(19) United States
(12) Patent Application Publication
(10) Pub. No.: US 2016/0086499 A1
(43) Pub. Date: Mar. 24, 2016

(54) KNOWLEDGE BROKERING AND KNOWLEDGE CAMPAIGNS

(71) Applicant: Kaybus, Inc., San Francisco, CA (US)

(72) Inventors: Tao Liang, Palo Alto, CA (US); Sanjay Mehta, Fremont, CA (US); Gazi Mahmud, Berkeley, CA (US); Rahul Ajmera, Bangalore (IN)

(21) Appl. No.: 14/920,535

(22) Filed: Oct. 22, 2015

Related U.S. Application Data
(63) Continuation-in-part of application No. 14/863,180, filed on Sep. 23, 2015.
(60) Provisional application No. 62/054,338, filed on Sep. 23, 2014.

(51) Int. Cl. G09B 5/00; G06F 17/30

(52) U.S. Cl. CPC G09B 5/00; G06F 17/30368; G06F 17/30554; G06F 17/30525

(57) ABSTRACT

Knowledge automation techniques may include receiving a description of a knowledge campaign, and selecting knowledge elements from a data store based on the description of the knowledge campaign. The selected knowledge elements can be compiled into the knowledge campaign, and the knowledge campaign can be provided to target users. The consumption progress of the knowledge campaign by the target users can be monitored, and can be displayed on a graphical user interface.

### CROSS-REFERENCES TO RELATED APPLICATIONS

The present application is a continuation-in-part of U.S. application Ser. No. 14/863,180, filed Sep. 23, 2015, entitled “Knowledge Brokering and Knowledge Campaigns,” which is a non-provisional of and claims the benefit and priority of U.S. Provisional Application No. 62/054,338, filed Sep. 23, 2014, entitled “Knowledge Brokering and Knowledge Campaigns,” the entire contents of both of which are incorporated herein by reference for all purposes.

### BACKGROUND

The present disclosure generally relates to knowledge automation. More particularly, techniques are disclosed for generation of knowledge campaigns and tracking the consumption progress of knowledge campaigns.

With the vast amount of data content available, users often suffer from information overload. For example, in an enterprise environment, a large corporation may store all the data that users need to complete their tasks. However, finding the right data for the right user can be challenging. Users may often spend substantial amount of time looking for a needle in a haystack in trying to find the right data to fill their particular needs from thousands of data files. In a collaborative environment, even after the right data is found, substantial amount of time may be needed to synthesis that data into a suitable output that can be consumed by others. The amount of time that users spend searching and synthesizing the data may also create excessive load on the enterprise computing systems and slow down the processing of other tasks.

In traditional training and learning environments, relevant training materials are manually defined by a supervisor or an instructor. This can lead to inconsistent results, such as conflicting or inadequate information disseminated by different supervisors or instructors. Furthermore, for information disseminated to users via a computer network (e.g., web-based training materials), it can be difficult to track the progress of how much material each user has gone through.

Embodiments of the present invention address these and other problems individually and collectively.

### BRIEF SUMMARY

The present disclosure generally relates to knowledge automation. More particularly, knowledge automation techniques are disclosed for transforming data content into knowledge suitable for consumption by users. The knowledge automation techniques may include techniques for generating knowledge campaigns from knowledge elements, and for tracking user consumption progress of the knowledge campaigns.

In some embodiments, the techniques may include receiving a description of a knowledge campaign, and selecting knowledge elements from a data store based on the description of the knowledge campaign. The selected knowledge elements can be compiled into the knowledge campaign, and the knowledge campaign can be provided to target users. The consumption progress of the knowledge campaign by the target users can be monitored, and be displayed on a graphical user interface.

In some embodiments, the techniques for displaying consumption progress on a graphical user interface may include displaying a graphical user interface including a first area, a second area, and a third area. In the first area, a first graphical element representing an aggregated consumption trend of the knowledge campaign over time can be displayed. In the second area, a second graphical element representing, for one or more user groups, coverage information about the target users in each user group can be displayed. In the third area, consumption information for each of one or more of the knowledge elements in the knowledge campaign can be displayed.

In some embodiments, the techniques may also include detecting user selection of the first area, and in response to detecting user selection of the first area, a list of user groups and a consumption trend of the knowledge campaign for each of one or more of the user groups can be displayed in a fourth area of the graphical user interface. When user deselection of a user group on the list of user groups whose consumption trend is being displayed in the fourth area is detected, the consumption trend of the deselected user group can be removed from the fourth area. When user selection of a user group on the list of user groups whose consumption trend is not being displayed in the fourth area is detected, display of the consumption trend of the selected user group can be added to the fourth area.

In some embodiments, the techniques may also include, in response to detecting the user selection of the second area, displaying multiple tiles in a fourth area of the graphical user interface. Each tile may correspond to a user group, and each tile may display the coverage information of the corresponding user group. In some embodiments, in response to detecting the user selection of the consumption information of a knowledge element in the third area, consumption information of the corresponding knowledge element by each of one or more of the target users can be displayed in a fourth area of the graphical user interface.

In some embodiments, a non-transitory computer-readable storage memory may store a plurality of instructions executable by one or more processors. The plurality of instructions may include instructions to perform the techniques described above. In some embodiments, a system may include one or more processors, and a memory coupled with and readable by the one or more processors. The memory can be configured to store a set of instructions which, when executed by the one or more processors, causes the one or more processors to perform the techniques described above.

### BRIEF DESCRIPTION OF THE DRAWINGS

FIG. 1 illustrates an environment in which a knowledge automation system can be implemented, according to some embodiments.

FIG. 2 illustrates a flow diagram depicting some of the processing that can be performed by a knowledge automation system, according to some embodiments.

FIG. 3 illustrates a block diagram of a knowledge automation system, according to some embodiments.

FIG. 4 illustrates a user profile, according to some embodiments.

FIG. 5 illustrates a user profile group, according to some embodiments.

FIG. 6 illustrates an example formation of a knowledge pack, according to some embodiments.

FIG. 7 illustrates a knowledge bank, according to some embodiments.

FIG. 8 illustrates a block diagram of a content synthesizer, according to some embodiments.

FIG. 9 illustrates a block diagram of a content analyzer, according to some embodiments.

FIG. 10 illustrates a flow diagram of a content discovery and ingestion process, according to some embodiments.

FIG. 11 illustrates a flow diagram of a content analysis process, according to some embodiments.

FIG. 12 illustrates a flow diagram of a knowledge campaign generation process, according to some embodiments.

FIG. 13 illustrates a graphical user interface for displaying a list of knowledge campaigns, according to some embodiments.

FIG. 14 illustrates a graphical user interface for displaying consumption progress of a knowledge campaign, according to some embodiments.

FIG. 15 illustrates a graphical user interface for displaying consumption trends of a knowledge campaign by user groups, according to some embodiments.

FIG. 16 illustrates a graphical user interface for displaying coverage information per user group, according to some embodiments.

FIG. 17 illustrates a graphical user interface for displaying consumption information of a knowledge element in the knowledge campaign at the user level, according to some embodiments.

FIG. 18 illustrates another graphical user interface for displaying consumption information of a knowledge element in the knowledge campaign at the user level, according to some embodiments.

FIG. 19 illustrates a flow diagram of a process for displaying consumption progress information of a knowledge campaign on a graphical user interface, according to some embodiments.

FIG. 20 depicts a block diagram of a computing system, according to some embodiments.

FIG. 21 depicts a block diagram of a service provider system, according to some embodiments.

### DETAILED DESCRIPTION

The present disclosure relates generally to knowledge automation. Certain techniques are disclosed for discovering data content and transforming information in the data content into knowledge units, and composing individual knowledge units into knowledge packs. Certain techniques are also disclosed for generating knowledge campaigns from knowledge elements (e.g., knowledge units and/or knowledge packs), and for tracking user consumption progress of the knowledge campaigns.

Substantial amounts of data (e.g., data files such as documents, emails, images, code, and other content, etc.) may be available to users in an enterprise. These users may rely on information contained in the data to assist them in performing their tasks. The users may also rely on information contained in the data to generate useful knowledge that is consumed by other users. For example, a team of users may take technical specifications related to a new product release, and generate a set of training materials for the technicians who will install the new product. However, the large quantities of data available to these users may make it difficult to identify the right information to use.

Machine learning techniques can analyze content at scale (e.g., enterprise-wide and beyond) and identify patterns of what is most useful to which users. Machine learning can be used to model both the content accessible by an enterprise system (e.g., local storage, remote storage, and cloud storage services, such as SharePoint, Google Drive, Box, etc.), and the users who request, view, and otherwise interact with the content. Based on a user's profile and how the user interacts with the available content, each user's interests, expertise, and peers can be modeled. The data content can then be matched to the appropriate users who would most likely be interested in that content. In this manner, the right knowledge can be provided to the right users at the right time. This not only improves the efficiency of the users in identifying and consuming knowledge relevant for each user, but also improves the efficiency of computing systems by freeing up computing resources that would otherwise be consumed by efforts to search and locate the right knowledge, and allowing these computing resources to be allocated for other tasks.

### I. Architecture Overview

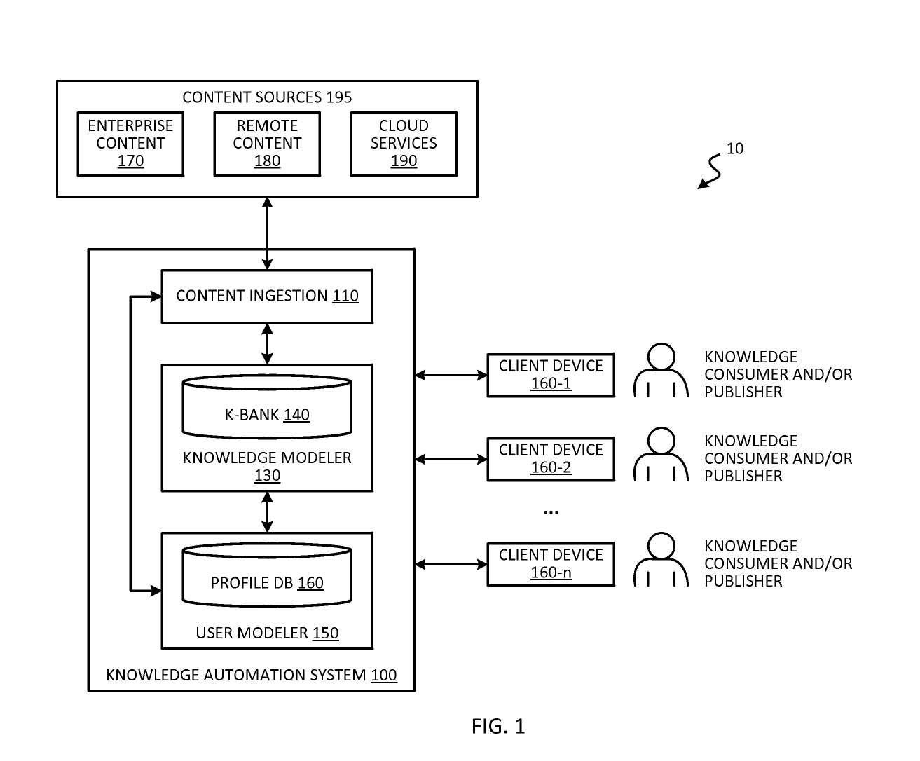

FIG. 1 illustrates an environment 10 in which a knowledge automation system 100 can be implemented, according to some embodiments. As shown in FIG. 1, a number of client devices 160-1, 160-2, . . . 160-n can be used by a number of users to access services provided by knowledge automation system 100. The client devices may be of various different types, including, but not limited to personal computers, desktops, mobile or handheld devices such as laptops, smart phones, tablets, etc., and other types of devices. Each of the users can be a knowledge consumer who accesses knowledge from knowledge automation system 100, or a knowledge publisher who publishes or generates knowledge in knowledge automation system 100 for consumption by other users. In some embodiments, a user can be both a knowledge consumer or a knowledge publisher, and a knowledge consumer or a knowledge publisher may refer to a single user or a user group that includes multiple users.

Knowledge automation system 100 can be implemented as a data processing system, and may discover and analyze content from one or more content sources 195 stored in one or more data repositories, such as a databases, file systems, management systems, email servers, object stores, and/or other repositories or data stores. In some embodiments, client devices 160-1, 160-2, . . . 160-n can access the services provided by knowledge automation system 100 through a network such as the Internet, a wide area network (WAN), a local area network (LAN), an Ethernet network, a public or private network, a wired network, a wireless network, or a combination thereof. Content sources 195 may include enterprise content 170 maintained by an enterprise, remote content 180 maintained at one or more remote locations (e.g., the Internet), cloud services content 190 maintained by cloud storage service providers, etc. Content sources 195 can be accessible to knowledge automation system 100 through a local interface, or through a network interface connecting knowledge automation system 100 to the content sources via one or more of the networks described above. In some embodiments, one or more of the content sources 195, one or more of the client devices 160-1, 160-2, . . . 160-n, and knowledge automation system 100 can be part of the same network, or can be part of different networks.

Each client device can request and receive knowledge automation services from knowledge automation system 100. Knowledge automation system 100 may include various software applications that provide knowledge-based services to the client devices. In some embodiments, the client devices can access knowledge automation system 100 through a thin client or web browser executing on each client device. Such software as a service (SaaS) models allow multiple different clients (e.g., clients corresponding to different customer entities) to receive services provided by the software applications without installing, hosting, and maintaining the software themselves on the client device.

Knowledge automation system 100 may include a content ingestion module 110, a knowledge modeler 130, and a user modeler 150, which collectively may extract information from data content accessible from content sources 195, derive knowledge from the extracted information, and provide recommendation of particular knowledge to particular clients. Knowledge automation system 100 can provide a number of knowledge services based on the ingested content. For example, a corporate dictionary can automatically be generated, maintained, and shared among users in the enterprise. A user's interest patterns (e.g., the content the user typically views) can be identified and used to provide personalized search results to the user. In some embodiments, user requests can be monitored to detect missing content, and knowledge automation system 100 may perform knowledge brokering to fill these knowledge gaps. In some embodiments, users can define knowledge campaigns to generate and distribute content to users in an enterprise, monitor the usefulness of the content to the users, and make changes to the content to improve its usefulness.

Content ingestion module 110 can identify and analyze enterprise content 170 (e.g., files and documents, other data such as e-mails, web pages, enterprise records, code, etc. maintained by the enterprise), remote content 180 (e.g., files, documents, and other data, etc. stored in remote databases), cloud services content 190 (e.g., files, documents, and other data, etc. accessible form the cloud), and/or content from other sources. For example, content ingestion module 110 may crawl or mine one or more of the content sources to identify the content stored therein, and/or monitor the content sources to identify content as they are being modified or added to the content sources. Content ingestion module 110 may parse and synthesize the content to identify the information contained in the content and the relationships of such information. In some embodiments, ingestion can include normalizing the content into a common format, and storing the content as one or more knowledge units in a knowledge bank 140 (e.g., a knowledge data store). In some embodiments, content can be divided into one or more portions during ingestion. For example, a new product manual may describe a number of new features associated with a new product launch. During ingestion, those portions of the product manual directed to the new features may be extracted from the manual and stored as separate knowledge units. These knowledge units can be tagged or otherwise be associated with metadata that can be used to indicate that these knowledge units are related to the new product features. In some embodiments, content ingestion module 110 may also perform access control mapping to restrict certain users from being able to access certain knowledge units.

Knowledge modeler 130 may analyze the knowledge units generated by content ingestion module 120, and combine or group knowledge units together to form knowledge packs. A knowledge pack may include various related knowledge units (e.g., several knowledge units related to a new product launch can be combined into a new product knowledge pack). In some embodiments, a knowledge pack can be formed by combining other knowledge packs, or a mixture of knowledge unit(s) and knowledge pack(s). The knowledge packs can be stored in knowledge bank 140 together with the knowledge units, or be stored separately. Knowledge modeler 130 may automatically generate knowledge packs by analyzing the topics covered by each knowledge unit, and combining knowledge units covering a similar topic into a knowledge pack. In some embodiments, knowledge modeler 130 may allow a user (e.g., a knowledge publisher) to build custom knowledge packs, and to publish custom knowledge packs for consumption by other users.

User modeler 150 may monitor user activities on the system as they interact with the knowledge bank 140 and the knowledge units and knowledge packs stored therein (e.g., the user's search history, knowledge units and knowledge packs consumed, knowledge packs published, time spent viewing each knowledge pack and/or search results, etc.). User modeler 150 may maintain a profile database 160 that stores user profiles for users of knowledge automation system 100. User modeler 150 may augment the user profiles with behavioral information based on user activities. By analyzing the user profile information, user modeler 150 can match a particular user to knowledge packs that the user may be interested in, and provide the recommendations to that user. For example, if a user has a recent history of viewing knowledge packs directed to a wireless networks, user modeler module 150 may recommend other knowledge packs directed to wireless networks to the user. As the user interacts with the system, user modeler 150 can dynamically modify the recommendations based on the user's behavior. User modeler 150 may also analyze search results performed by users to determine the effectiveness of the search results successful (e.g., did the user select and use the results), and to identify potential knowledge gaps in the system. In some embodiments, user modeler 150 may provide these knowledge gaps to content ingestion module 310 to find useful content to fill the knowledge gaps.

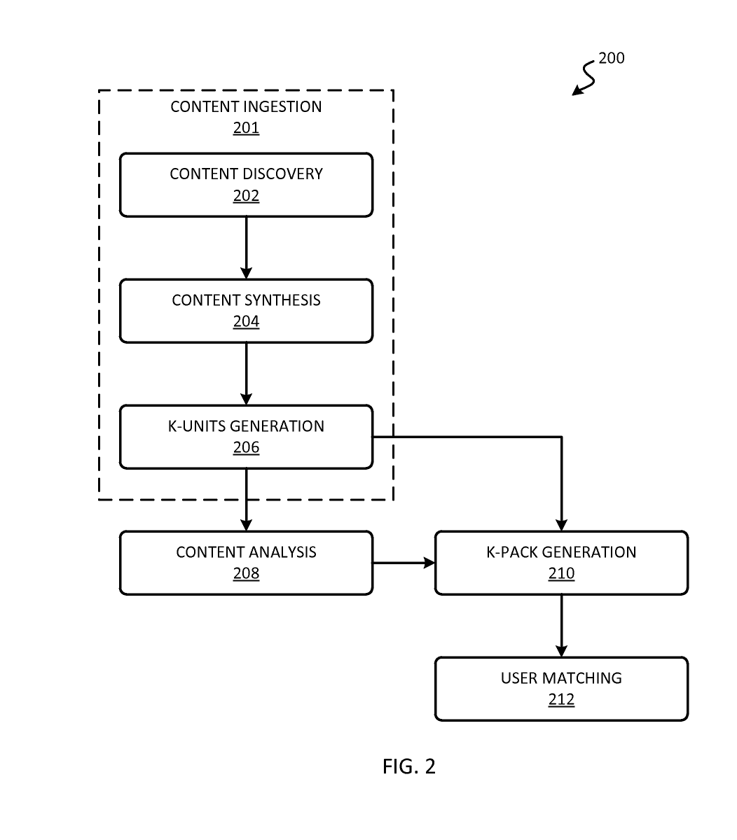

FIG. 2 illustrates a simplified flow diagram 200 depicting some of the processing that can be performed, for example, by a knowledge automation system, according to some embodiments. The processing depicted in FIG. 2 may be implemented in software (e.g., code, instructions, program) executed by one or more processing units (e.g., processors, cores), hardware, or combinations thereof. The software may be stored in memory (e.g., on a non-transitory computer-readable storage medium such as a memory device).

The processing illustrated in flow diagram 200 may begin with content ingestion 201. Content ingestion 201 may include content discovery 202, content synthesis 204, and knowledge units generation 206. Content ingestion 201 can be initiated at block 202 by performing content discovery to identify and discover data content (e.g., data files) at one or more data sources such as one or more data repositories. At block 204, content synthesis is performed on the discovered data content to identify information contained in the content. The content synthesis may analyze text, patterns, and metadata variables of the data content.

At block 206, knowledge units are generated from the data content based on the synthesized content. Each knowledge unit may represent a chunk of information that covers one or more related subjects. The knowledge units can be of varying sizes. For example, each knowledge unit may correspond to a portion of a data file (e.g., a section of a document) or to an entire data file (e.g., an entire document, an image, etc.). In some embodiments, multiple portions of data files or multiple data files can also be merged to generate a knowledge unit. By way of example, if an entire document is focused on a particular subject, a knowledge unit corresponding to the entire document can be generated. If different sections of a document are focused on different subjects, then different knowledge units can be generated from the different sections of the document. A single document may also result in both a knowledge unit generated for the entire document as well as knowledge units generated from portions of the document. As another example, various email threads relating to a common subject can be merged into a knowledge unit. The generated knowledge units are then indexed and stored in a searchable knowledge bank.

At block 208, content analysis is performed on the knowledge units. The content analysis may include performing semantics and linguistics analyses and/or contextual analysis on the knowledge units to infer concepts and topics covered by the knowledge units. Key terms (e.g., keywords and key phrases) can be extracted, and each knowledge unit can be associated with a term vector of key terms representing the content of the knowledge unit. In some embodiments, named entities can be identified from the extracted key terms. Examples of named entities may include place names, people's names, phone numbers, social security numbers, business names, dates and time values, etc. Knowledge units covering similar concepts can be clustered, categorized, and tagged as pertaining to a particular topic or topics. Taxonomy generation can also be performed to derive a corporate dictionary identifying key terms and how the key terms are used within an enterprise.

At block 210, knowledge packs are generated from individual knowledge units. The knowledge packs can be automatically generated by combining knowledge units based on similarity mapping of key terms, topics, concepts, metadata such as authors, etc. In some embodiments, a knowledge publisher can also access the knowledge units generated at block 206 to build custom knowledge packs. A knowledge map representing relationships between the knowledge packs can also be generated to provide a graphical representation of the knowledge corpus in an enterprise.

At block 212, the generated knowledge packs are mapped to knowledge consumers who are likely to be interested in the particular knowledge packs. This mapping can be performed based on information about the user (e.g., user's title, job function, etc.), as well as learned behavior of the user interacting with the system (e.g., knowledge packs that the user has viewed and consumed in the past, etc.). The user mapping can also take into account user feedback (e.g., adjusting relative interest levels, search queries, ratings, etc.) to tailor future results for the user. Knowledge packs mapped to a particular knowledge consumer can be distributed to the knowledge consumer by presenting the knowledge packs on a recommendations page for the knowledge consumer.

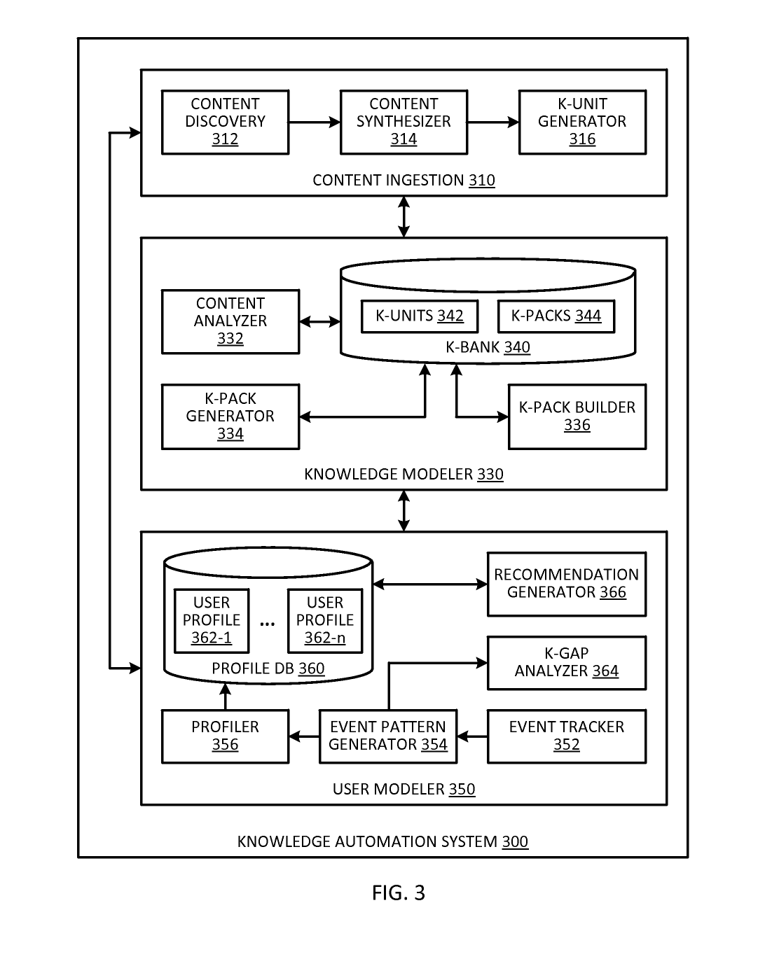

FIG. 3 illustrates a more detailed block diagram of a knowledge automation system 300, according to some embodiments. Knowledge automation system 300 can be implemented as a data processing system, and may include a content ingestion module 310, a knowledge modeler 330, and a user modeler 350. In some embodiments, the processes performed by knowledge automation system 300 can be performed in real-time. For example, as the data content or knowledge corpus available to the knowledge automation system changes, knowledge automation system 300 may react in real-time and adapt its services to reflect the modified knowledge corpus.

Content ingestion module 310 may include a content discovery module 312, a content synthesizer 314, and a knowledge unit generator 316. Content discovery module 312 interfaces with one or more content sources to discover contents stored at the content sources, and to retrieve the content for analysis. In some embodiments, knowledge automation system 300 can be deployed to an enterprise that already has a pre-existing content library. In such scenarios, content discovery module 312 can crawl or mine the content library for existing data files, and retrieve the data files for ingestion. In some embodiments, the content sources can be continuously monitored to detect the addition, removal, and/or updating of content. When new content is added to a content source or a pre-existing content is updated or modified, content discovery module 312 may retrieve the new or updated content for analysis. New content may result in new knowledge units being generated, and updated content may result in modifications being made to affected knowledge units and/or new knowledge units being generated. When content is removed from a content source, content discovery module 312 may identify the knowledge units that were derived from the removed content, and either remove the affected knowledge units from the knowledge bank, or tag the affected knowledge units as being potentially invalid or outdated.

Content synthesizer 314 receives content retrieved by content discovery module 312, and synthesizes the content to extract information contained in the content. The content retrieved by content discovery module 312 may include different types of content having different formats, storage requirements, etc. As such, content synthesizer 314 may convert the content into a common format for analysis. Content synthesizer 314 may identify key terms (e.g., keywords and/or key phrases) in the content, determine a frequency of occurrence of the key terms in the content, and determining locations of the key terms in the content. In addition to analyzing information contained in the content, content synthesizer 314 may also extract metadata associated with the content (e.g., author, creation date, title, revision history, etc.).

Knowledge unit generator 314 may then generate knowledge units from the content based on patterns of key terms used in the content and the metadata associated with the content. For example, if a document has a large frequency of occurrence of a key term in the first three paragraphs of the document, but a much lower frequency of occurrence of that same key term in the remaining portions of the document, the first three paragraphs of the document can be extracted and formed into a knowledge unit. As another example, if there is a large frequency of occurrence of a key term distributed throughout a document, the entire document can be formed into a knowledge unit. The generated knowledge units are stored in a knowledge bank 340, and indexed based on the identified key terms and metadata to make the knowledge units searchable in knowledge bank 340.

Knowledge modeler 330 may include content analyzer 332, knowledge bank 340, knowledge pack generator 334, and knowledge pack builder 336. Content analyzer 332 may perform various types of analyses on the knowledge units to model the knowledge contained in the knowledge units. For example, content analyzer 332 may perform key term extraction and entity (e.g., names, companies, organizations, etc.) extraction on the knowledge units, and build a taxonomy of key terms and entities representing how the key terms and entities are used in the knowledge units. Content analyzer 332 may also perform contextual, sematic, and linguistic analyses on the knowledge units to infer concepts and topics covered by the knowledge units. For example, natural language processing can be performed on the knowledge units to derive concepts and topics covered by the knowledge units. Based on the various analyses, content analyzer 332 may derive a term vector for each knowledge unit to represent the knowledge contained in each knowledge unit. The term vector for a knowledge unit may include key terms, entities, and dates associated with the knowledge unit, topic and concepts associated with the knowledge unit, and/or other metadata such as authors associated with the knowledge unit. Using the term vectors, content analyzer 332 may perform similarity mapping between the knowledge units to identify knowledge units that cover similar topics or concepts.

Knowledge pack generator 334 may analyze the similarity mapping performed by content analyzer 332, and automatically form knowledge packs by combining similar knowledge units. For example, knowledge units that share at least five common key terms can be combined to form a knowledge pack. As another example, knowledge units covering the same topic can be combined to form a knowledge pack. In some embodiments, a knowledge pack may include other knowledge packs, or a combination of knowledge pack(s) and knowledge unit(s). For example, knowledge packs that are viewed and consumed by the a set of users can be combined into a knowledge pack. The generated knowledge packs can be tagged with their own term vectors to represent the knowledge contain in the knowledge pack, and be stored in knowledge bank 340.

Knowledge pack builder 336 may provide a user interface to allow knowledge publishers to create custom knowledge packs. Knowledge pack builder 336 may present a list of available knowledge units to a knowledge publisher to allow the knowledge publisher to select specific knowledge units to include in a knowledge pack. In this manner, a knowledge publisher can create a knowledge pack targeted to specific knowledge consumers. For example, a technical trainer can create a custom knowledge pack containing knowledge units covering specific new features of a produce to train a technical support staff. The custom knowledge packs can also be tagged and stored in knowledge bank 340.

Knowledge bank 340 is used for storing knowledge units 342 and knowledge packs 344. Knowledge bank 340 can be implemented as one or more data stores. Although knowledge bank 340 is shown as being local to knowledge automation system 300, in some embodiments, knowledge bank 340, or part of knowledge bank 340 can be remote to knowledge automation system 300. In some embodiments, frequently requested, or otherwise highly active or valuable knowledge units and/or knowledge packs, can be maintained in a low latency, multiple redundancy data store. This makes the knowledge units and/or knowledge packs quickly available when requested by a user. Infrequently accessed knowledge units and/or knowledge packs may be stored separately in slower storage.

Each knowledge unit and knowledge pack can be assigned an identifier that is used to identify and access the knowledge unit or knowledge pack. In some embodiments, to reduce memory usage, instead of storing the actual content of each knowledge unit in knowledge bank 340, the knowledge unit identifier referencing the knowledge unit and the location of the content source of the content associated with the knowledge unit can be stored. In this manner, when a knowledge unit is accessed, the content associated with the knowledge unit can be retrieved from the corresponding content source. For a knowledge pack, an knowledge pack identifier referencing the knowledge pack, and the identifiers and locations of the knowledge units and/or knowledge packs that make up the knowledge pack can be stored. Thus, a particular knowledge pack can be thought of as a container or a wrapper object for the knowledge units and/or knowledge packs that make up the particular knowledge pack. In some embodiments, knowledge bank 340 may also store the actual content of the knowledge units, for example, in a common data format. In some embodiments, knowledge bank 340 may selectively store some content while not storing other content (e.g., content of new or frequently accessed knowledge units can be stored, whereas stale or less frequently accessed content are not stored in knowledge bank 340).

Knowledge units 342 can be indexed in knowledge bank 340 according to key terms contained in the knowledge unit (e.g., may include key words, key phrases, entities, dates, etc. and number of occurrences of such in the knowledge unit) and/or associated metadata (e.g., author, location such as URL or identifier of the content, date, language, subject, title, file or document type, etc.). In some embodiments, the metadata associated with a knowledge unit may also include metadata derived by knowledge automation system 300. For example, this may include information such as access control information (e.g., which user or user group can view the knowledge unit), topics and concepts covered by the knowledge unit, knowledge consumers who have viewed and consumed the knowledge unit, knowledge packs that the knowledge unit is part of, time and frequency of access, etc.). Knowledge packs 344 stored in knowledge bank may include knowledge packs automatically generated by the system, and/or custom knowledge packs created by users (e.g., knowledge publishers). Knowledge packs 344 may also be indexed in a similar manner as for knowledge packs described above. In some embodiments, the metadata for a knowledge pack may include additional information that a knowledge unit may not have. For example, these may include a category type (e.g., newsletter, emailer, training material, etc.), editors, target audience, etc.

In some embodiments, a term vector can be associated with each knowledge element (e.g., a knowledge unit and/or a knowledge pack). The term vector may include key terms, metadata, and derived metadata associated with the each knowledge element. In some embodiments, instead of including all key terms present in a knowledge element, the term vector may include a predetermined number of key terms with the highest occurrence count in the knowledge element (e.g., the top five key terms in the knowledge element, etc.), or key terms that have greater than a minimum number of occurrences (e.g., key terms that appear more than ten times in a knowledge element, etc.).

User modeler 350 may include an event tracker 352, an event pattern generator 354, a profiler 356, a knowledge gap analyzer 364, a recommendations generator 366, and a profile database 360 that stores a user profile for each user of knowledge automation system 300. Event tracker 352 monitors user activities and interactions with knowledge automation system 300. For example, the user activities and interactions may include knowledge consumption information such as which knowledge unit or knowledge pack that a user has viewed, the length of time spent on the knowledge unit/pack, and when did the user access the knowledge unit/pack. The user activities and interactions tracked by event tracker 352 may also include search queries performed by the users, and user responses to the search results (e.g., number and frequency of similar searches performed by the same user and by other users, amount of time a user spends on reviewing the search result, how deep into a result list the user traversed, the number of items in the result list the user accessed and length of time spend on each item, etc.). If a user is a knowledge publisher, event tracker 352 may also track the frequency that the knowledge publisher publishes, when the knowledge publisher publishes, and topics or categories that the knowledge publisher publishes in, etc.

Event pattern generator 354 may analyze the user activities and interactions tracked by event tracker 352, and derive usage or event patterns for users or user groups. Profiler 356 may analyze these patterns and augment the user profiles stored in profile database 360. For example, if a user has a recent history of accessing a large number of knowledge packs relating to a particular topic, profiler 356 may augment the user profile of this user with an indication that this user has an interest in the particular topic. For patterns relating to search queries, knowledge gap analyzer 364 may analyze the search query patterns and identify potential knowledge gaps relating to certain topics in which useful information may be lacking in the knowledge corpus. Knowledge gap analyzer 364 may also identify potential content sources to fill the identified knowledge gaps. For example, a potential content source that may fill a knowledge gap can be a knowledge publisher who frequently publishes in a related topic, the Internet, or some other source from which information pertaining to the knowledge gap topic can be obtained.

Recommendations generator 366 may provide a knowledge mapping service that provides knowledge pack recommendations to knowledge consumers of knowledge automation system 300. Recommendations generator 366 may compare the user profile of a user with the available knowledge packs in knowledge bank 340, and based on the interests of the user, recommend knowledge packs to the user that may be relevant for the user. For example, when a new product is released and a product training knowledge pack is published for the new product, recommendations generator 366 may identify knowledge consumers who are part of a sales team, and recommend the product training knowledge pack to those users. In some embodiments, recommendations generator 366 may generate user signatures form the user profiles and knowledge signatures from the knowledge elements (e.g., knowledge units and/or knowledge packs), and make recommendations based on comparisons of the user signatures to the knowledge signatures. The analysis can be performed by recommendations generator 366, for example, when a new knowledge pack is published, when a new user is added, and/or when the user profile of a user changes.

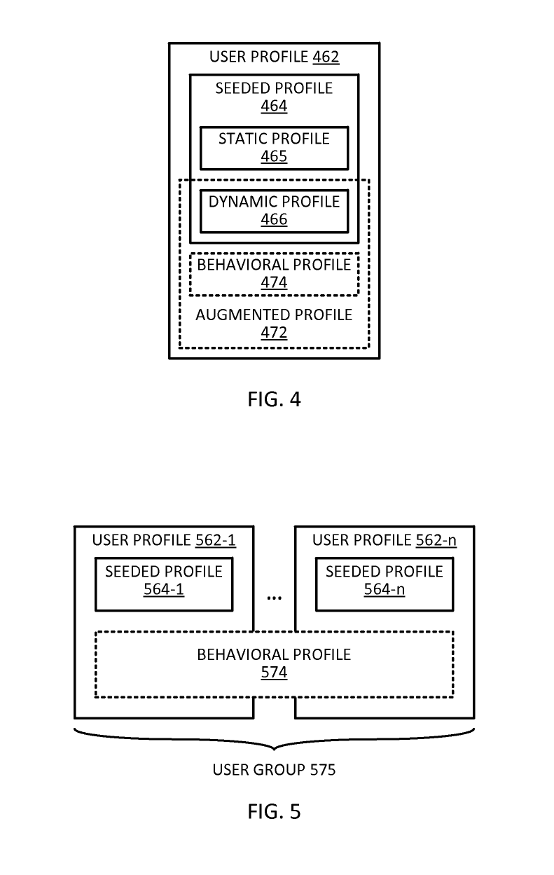

FIG. 4 illustrates a user profile 462 associated with a user of a knowledge automation system, according to some embodiments. User profile 462 can be stored, for example, in a user profile database. User profile 462 may include a seeded profile 464, and an augmented profile 472. Seeded profile 464 may include information about the user that is seeded or provided to the system when the user enrolls or registers in the knowledge automation system. For example, seeded profile 464 may include information such as the name of the user, the location and/or time zone of the user, role and/or job function of the user, work group the user is part of, experience of the user, expertise of the user, etc. Seeded profile 464 may include a static profile 465 that is generally static and does not change often for a user. For example, information such as name, location and/or time zone, and role and/or job function, etc. may be part of the static profile 465. Seeded profile 464 may also include a dynamic profile 466 that includes seeded information about a user that may change over time. For example, information such as work group, experience, and expertise, etc. can be part of dynamic profile 466, because the user's experience and expertise may grow over time, and the user can be placed on different teams over time.

Augmented profile 472 may include information about the user that the knowledge automation system modifies or adds to user profile 462. Augmented profile 472 may include information about the user that the knowledge automation system learns over time via monitoring of the user's activities and interactions with the system. Augmented profile 472 may include dynamic profile 466 that overlaps with seeded profile 464. For example, if the user has been consuming a large amount of knowledge about a particular topic, the knowledge automation system may add that topic to the user's seeded expertise. As another example, as the user completes one project and is placed on a different project team, the knowledge automation system may modify the seeded work group of the user to reflect this change.

Augmented profile 472 also includes behavioral profile 474 that represents the user's usage patterns in the knowledge automation system. For example, behavioral profile 474 may include information such as topics and/or publishers of knowledge packs that the user consumes, categories of knowledge packs that the user consumes, key terms that the user searches for, topics of knowledge packs that the user publishes, etc. Based on the user's activities and interactions with the system, the knowledge automation system may infer specific topics that the user may be interested in. In some embodiments, the user may be allowed to adjust the user's interest level of the topics that the knowledge automation system inferred, and this information can be included in behavioral profile 474.

In some embodiments, the knowledge automation system may group multiple users into a user group. A user group can be formed based on common attributes of the users. For example, users in the same work group can be formed into a user group, or users at the same location or time zone can be formed into a user group, etc. In some embodiments, a user group can be formed based on common behaviors of the users. For example, if a set of users often consumes knowledge packs on a particular topic, these users can be formed into a user group. As another example, if a set of users often publishes a particular category of knowledge packs, these users can be formed into a user group. It should be understood that a user can belong to more than one user group.

FIG. 5 illustrates user profiles of users belonging to a user group 575, according to some embodiments. User group 575 may include any number of users, and may include a user associated with user profile 562-1, and a user associated with user profile 562-n. User profiles 562-1 and 562-n may have respective seeded profiles 564-1 and 564-n. In some embodiments, because these users are part of the same user group 575, the knowledge automation system may augment user profiles 562-1 and 562-n with a group behavioral profile 574 across the entire user group based on the behaviors of members in the groups. For example, if knowledge automation system determines that a large number of members in user group 575 are interested in mobile device security, even though the user associated with user profile 562-1 may not have shown an interest in this topic, user profile 562-1 (as well as other user profiles of members in the group) may nevertheless be augmented to include mobile device security as a topic that the user may be interested in, because the user is part of user group 575. In this manner, the behaviors of members in a user group can be inferred to other members in the same user group. This allows the knowledge automation system to make knowledge recommendations to a user based on the not just the activities and interactions of that particular user alone, but also based on the activities and interactions of other users who are similar to that particular user.

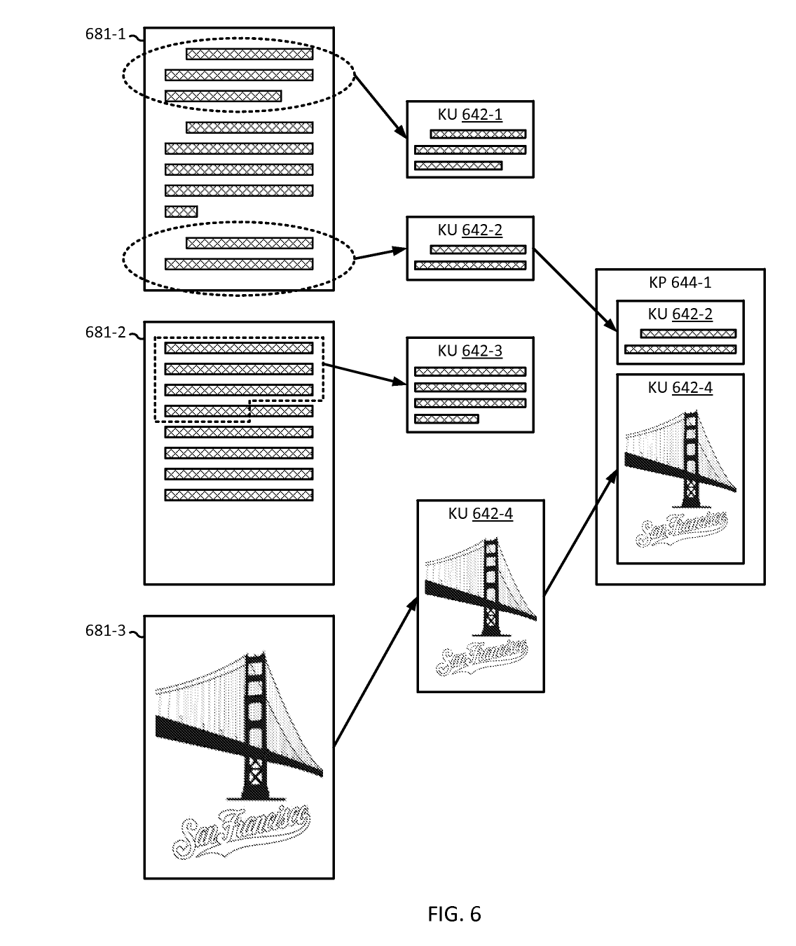

FIG. 6 illustrates an example formation of a knowledge pack from data content, according to some embodiments. In the example shown in FIG. 6, the data content discovered by the knowledge automation system may include a structured text file 681-1, an unstructured text file 681-2, and an image file 681-3.

Structured text file 681-1 can be parsed and analyzed based in part on the organization and structure of the document. For example, structured text file 681-1 may be organized into three paragraphs. The knowledge automation system may analyze structured text file 681-1, and determine that the first paragraph pertains to information about the state of California, the second paragraph discusses major cities on the west coast, and the third paragraph pertains to information about the city of San Francisco. This determination can be made, for example, based on a high frequency count of the key term “California” appearing in the first paragraph, various city names appearing in the second paragraph, and a high frequency count of the key term “San Francisco” appearing in the third paragraph. Based on this analysis, the knowledge automation system may segment structured text document 681-1 into individual paragraphs, and form a knowledge unit 642-1 directed to “California” from the first paragraph, and a knowledge unit 642-2 directed to “San Francisco” from the third paragraph.

Unstructured text file 681-2 may include a text blob without any apparent organization or structure in the document. The knowledge automation system may perform key term analysis on unstructured text file 681-2, and determine that the first portion of the document includes a high frequency count of the key term “California,” whereas the second portion of the document does not have any repeated key words or key phrases. Based on this analysis, the knowledge automation system may extract the first portion where the key term “California” appears repeatedly, and form a knowledge unit 642-3 directed to “California” from the first portion of unstructured text file 681-2.

Image file 681-3 may include a picture of the word “San Francisco.” The knowledge automation system may perform optical character recognition on image file 681-3, and extract the key term “San Francisco” from the picture. Based on this analysis, the knowledge automation system may form a knowledge unit 642-4 directed to “San Francisco” from image file 681-3.

Having generated knowledge units 642-1, 642-2, 642-3, and 642-4, the knowledge automation system may analyze the available knowledge units, and form knowledge packs by combining knowledge units directed to similar topics. For example, the knowledge automation system may form a knowledge pack 644-1 directed to the topic “San Francisco” by combining knowledge unit 642-2 and knowledge unit 642-4, which the knowledge automation system has tagged as being related to the topic “San Francisco.”

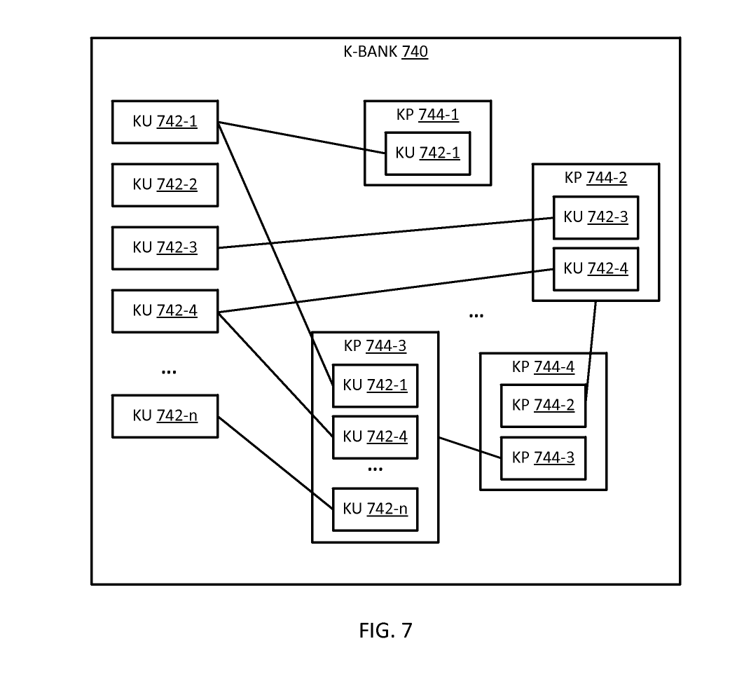

FIG. 7 illustrates a conceptual diagram of an example of the contents in a knowledge bank 740, according to some embodiments. Knowledge bank 740 may store the knowledge corpus of the knowledge automation system, and may include knowledge units 741-1 to 741-n. Knowledge units 741-1 to 741-n can be generated by the knowledge automation system from data content available in one or more content sources using the content discovery and ingestion techniques described herein. Based on the similarity mapping between knowledge units 741-1 to 741-n, or based on a input from knowledge publishers, knowledge packs 744-1 to 744-4 can be formed. For example, knowledge pack 744-1 can be generated from a single knowledge unit 742-1. Knowledge pack 744-2 can be generated by combining knowledge units 742-3 and 742-4. Knowledge pack 744-3 can be generated by combining knowledge units 742-1 and 742-4 to 742-n. Knowledge pack 744-4 can be generated by combining knowledge packs 744-2 and 744-3.

As this example illustrates, a single knowledge unit (e.g., knowledge unit 742-1) can be part of multiple knowledge packs (e.g., knowledge packs 744-1 and 744-3). A knowledge pack (e.g., knowledge pack 744-1) may include a single knowledge unit (e.g., knowledge unit 742-1). A knowledge pack (e.g., knowledge pack 744-2) may also include more than one knowledge unit (e.g., knowledge units 742-3 and 742-4). A knowledge pack (e.g., knowledge pack 744-4) may include other knowledge packs (e.g., knowledge packs 744-2 and 744-3). In some embodiments, a knowledge pack may also include a combination of one or more knowledge units and one or more knowledge packs.

### II. Content Discovery, Ingestion, and Analyses

Data content can come in many different forms. For example, data content (may be referred to as “data files”) can be in the form of text files, spreadsheet files, presentation files, image files, media files (e.g., audio files, video files, etc.), data record files, communication files (e.g., emails, voicemails, etc.), design files (e.g., computer aided design files, electronic design automation files, etc.), webpages, information or data management files, source code files, and the like. With the vast amount of data content that may be available to a user, finding the right data files with content that matters for the user can be challenging. A user may search an enterprise repository for data files pertaining to a particular topic. However, the search may return a large number of data files, where meaningful content for the user may be distributed across different data files, and some of the data files included in the search result may be of little relevance. For example, a data file that mentions a topic once may be included in the search result, but the content in the data file may have little to do with searched topic. As a result, a user may have to review a large number of data files to find useful content to fills the user's needs.

A knowledge modeling system according to some embodiments can be used to discover and assemble data content from different content sources, and organize the data content into packages for user consumption. Data content can be discovered from different repositories, and data content in different formats can be converted into a normalized common format for consumption. In some embodiments, data content discovered by the knowledge automation system can be separated into individual renderable portions. Each portion of data content can be referred to as a knowledge unit, and stored in a knowledge bank. In some embodiments, each knowledge unit can be associated with information about the knowledge unit, such as key terms representing the content in the knowledge unit, and metadata such as content properties, authors, timestamps, etc. Knowledge units that are related to each other (e.g., covering similar topics) can be combined together to form knowledge packs. By providing such knowledge packs to a user for consumption, the time and effort that a user spends on finding and reviewing data content can be reduced. Furthermore, the knowledge packs can be stored in the knowledge bank, and be provided to other users who may be interested in similar topics. Thus, the content discovery and ingestion for a fixed set of data content can be performed once, and may only need to be repeated if new data content is added, or if the existing data content is modified.

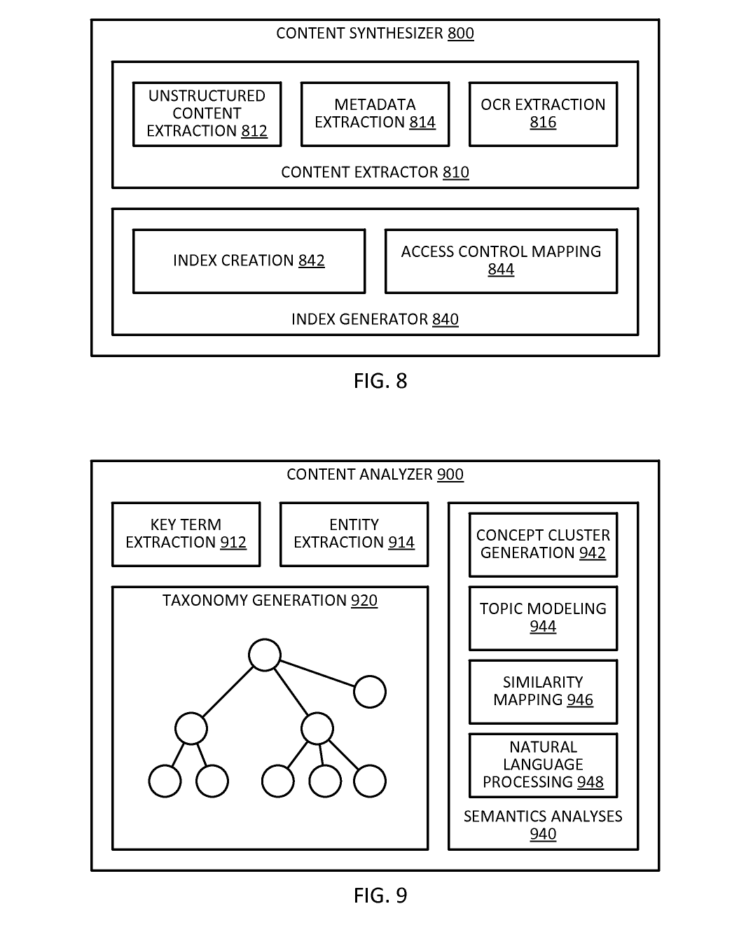

FIG. 8 illustrates a block diagram of a content synthesizer 800 that can be implemented in a knowledge automation system, according to some embodiments. Content synthesizer 800 can process content in discovered data files, and form knowledge units based on the information contained in the data files. A knowledge unit can be generated from the entire data file, from a portion of the data file, and/or a combination of different sequential and/or non-sequential portions of the data file. A data file may also result in multiple knowledge units being generated from that data file. For example, a knowledge unit can be generated from the entire data file, and multiple knowledge units can be generated from different portions or a combination of different portions of that same data file.

The data files provided to content synthesizer 800 can be discovered by crawling or mining one or more content repositories accessible to the knowledge automation system. Content synthesizer 800 may include a content extractor 810 and an index generator 840. Content extractor 810 can extract information from the data files, and organize the information into knowledge units. Index generator 840 is used to index the knowledge units according to extracted information.

Content extractor 810 may process data files in various different forms, and convert the data files into a common normalized format. For example, content extractor 810 may normalize all data files and convert them into a portable document format. If the data files include text in different languages, the languages can be translated into a common language (e.g., English). Data files such as text documents, spreadsheet documents, presentations, images, data records, etc. can be converted from their native format into the portable document format. For media files such as audio files, the audio can be transcribed and the transcription text can be converted into the portable document format. Video files can be converted into a series of images, and the images can be converted into the portable document format. If the data file include images, optical character recognition (OCR) extraction 816 can be performed on the images to extract text appearing in the images. In some embodiments, object recognition can also be performed on the images to identify objects depicted in the images.

In some embodiments, a data file may be in the form of an unstructured document that may include content that lacks organization or structure in the document (e.g., a text blob). In such cases, content extractor 810 may perform unstructured content extraction 812 to derive relationships of the information contained in the unstructured document. For example, content extractor 810 may identifying key terms used in the document (e.g., key words or key phrases that have multiple occurrences in the document), and the locations of the key terms in the document, and extract portions of the document that have a high concentration of certain key term. For example, if a key term is repeatedly used in the first thirty lines of the document, but does not appear or has a low frequency of occurrence in the remainder of the document, the first thirty lines of the document may be extracted from the document and formed into a separate knowledge unit.

For structured documents, a similar key term analysis can be performed. Furthermore, the organization and structure of the document can be taken into account. For example, different sections or paragraphs of the document having concentrations of different key terms can be extracted from the document and formed into separate knowledge segments, and knowledge units can be formed from the knowledge segments. Thus, for a structured document, how the document is segmented to form the knowledge units can be based in part on how the content is already partitioned in the document.

In addition to extracting information contained in the data files, content extractor 810 may also perform metadata extraction 814 to extract metadata associated with the data files. For example, metadata associated with a data file such as author, date, language, subject, title, file or document type, storage location, etc. can be extracted, and be associated with the knowledge units generated from the data file. This allows the metadata of a data file to be preserved and carried over to the knowledge units, for example, in cases where knowledge units are formed from portions of the data file.

Index generator 840 may perform index creation 842 and access control mapping 844 for the discovered data files and/or knowledge units generated therefrom. Index creation 842 may create, for each data file and/or knowledge unit, a count of the words and/or phrases appearing in the data file and/or knowledge unit (e.g., a frequency of occurrence). Index creation 842 may also associate each word and/or phrase with the location of the word and/or phrase in the data file and/or knowledge unit (e.g., an offset value representing the number of words between the beginning of the data file and the word or phrase of interest).

Access control mapping 844 may provide a mapping of which users or user groups may have access to a particular data file (e.g., read permission, write permission, etc.). In some embodiments, this mapping can be performed automatically based on the metadata associated with the data file or content in the data file. For example, if a document includes the word “confidential” in the document, access to the document can be limited to executives. In some embodiments, to provide finer granularity, access control mapping 844 can be performed on each knowledge unit. In some cases, a user may have access to a portion of a document, but not to other portions of the document.

FIG. 9 illustrates a block diagram of a content analyzer 900 that can be implemented in a knowledge automation system, according to some embodiments. Content analyzer 900 may analyze the generated knowledge units, and determine relationships between the knowledge units. Content analyzer 900 may perform key term extraction 912, entity extraction 914, taxonomy generation 920, and semantics analyses 940. In some embodiments, content analyzer 900 may derive a term vector representing the content in each knowledge unit based on the analysis, and associate the knowledge unit with the term vector.

Key term extraction 912 can be used to extract key terms (e.g., key words and/or key phrases) that appear in a knowledge unit, and determine the most frequently used key terms (e.g., top ten, twenty, etc.) in a knowledge unit. In some embodiments, key term extraction 912 may take into account semantics analyses performed on the knowledge unit. For example, pronouns appearing in a knowledge unit can be mapped back to the term substituted by the pronoun, and be counted as an occurrence of that term. In addition to extracting key terms, content analyzer 900 may also perform entity extraction 914 for entities appearing in or associated with the knowledge unit. Such entitles may include people, places, companies and organizations, authors or contributors of the knowledge unit, etc. In some embodiments, dates appearing in or associated with the knowledge unit can also be extracted. From this information, content analyzer 900 may derive a term vector for each knowledge unit to represent the content in each knowledge unit. For example, the term vector may include most frequently used key terms in the knowledge unit, entities and/or dates associated with the knowledge unit, and/or metadata associated with the knowledge unit.

Semantics analyses 940 performed on the knowledge units by content analyzer 900 may include concept cluster generation 942, topic modeling 944, similarity mapping 946, and natural language processing 948. Concept cluster generation 942 may identify concepts or topics covered by the knowledge units that are similar to each other, and cluster or group together the related concepts or topics. In some embodiments, concept cluster generation 942 may form a topic hierarchy of related concepts. For example, topics such as “teen smoking,” “tobacco industry,” and “lung cancer” can be organized as being under the broader topic of “smoking.”

Topic modeling 944 is used to identify key concepts and themes covered by each knowledge unit, and to derive concept labels for the knowledge units. In some embodiments, key terms that have a high frequency of occurrence (e.g., key terms appearing more than a predetermined threshold number such as key terms appearing more than a hundred times) can be used as the concept labels. In some embodiments, topic modeling 944 may derive concept labels contextually and semantically. For example, suppose the terms “airline” and “terminal” are used in a knowledge unit, but the terms do not appear next to each other in the knowledge unit. Topic modeling 944 may nevertheless determine that the “airline terminal” is a topic covered by the knowledge unit, and used this phrase as a concept label. A knowledge unit can be tagged with the concept or concepts that the knowledge unit covers, for example, by including one or more concept labels in the term vector for the knowledge unit.

Similarity mapping 946 can determine how similar a knowledge unit is to other knowledge units. In some embodiments, a knowledge unit distance metric can be used to make this determination. For example, the term vector associated with a knowledge unit can be modeled as a n-dimensional vector. Each key term or group of key terms can be modeled as a dimension. The frequency of occurrence for a key term or group of key terms can be modeled as another dimension. Concept or concepts covered by the knowledge unit can be modeled as a further dimension. Other metadata such as author or source of the knowledge unit can each be modeled as other dimensions, etc. Thus, each knowledge unit can be modeled as vector in n-dimensional space. The similarity between two knowledge units can then be determined by computing a Euclidean distance in n-dimensional space between the end points of the two vectors representing the two knowledge units. In some embodiments, certain dimensions may be weighted differently than other dimensions. For example, the dimension representing key terms in a knowledge unit can be weighted more heavily than the dimensions representing metadata in the Euclidean distance computation (e.g., by including a multiplication factor for the key term dimension in the Euclidean distance computation). In some embodiments, certain attributes of the knowledge unit (e.g., author, etc.) can also be masked such that the underlying attribute is not included in the Euclidean distance computation.

Natural language processing 948 may include linguistic and part-of-speech processing (e.g., verb versus noun, etc.) of the content and words used in the knowledge unit, and tagging of the words as such. Natural language processing 948 may provide context as to how a term is being used in the knowledge unit. For example, natural language processing 948 can be used to identify pronouns and the words or phrases being substituted by pronouns. Natural language processing 948 can also filter out article words such as “a” and “the” that content analyzer 900 may ignore. Different forms of a term (e.g., past tense, present tense, etc.) can also be normalized into its base term. Acronyms can also be converted into their expanded form.

In some embodiments, based on the extracted key terms and entities, and semantic analyses, content analyzer 900 may also perform taxonomy generation 920 to form a corporate dictionary. The taxonomy generation 920 may identify commonly used terms in the knowledge corpus, and how each term is used. For example, taxonomy generation 920 may link each term to snippets of the knowledge units that use the term. In some embodiments, taxonomy generation 920 may also create a hierarchy of related terms. For example, the term “smoking” may link to other terms such as “teen smoking,” “tobacco industry,” and “lung cancer” in the corporate dictionary.

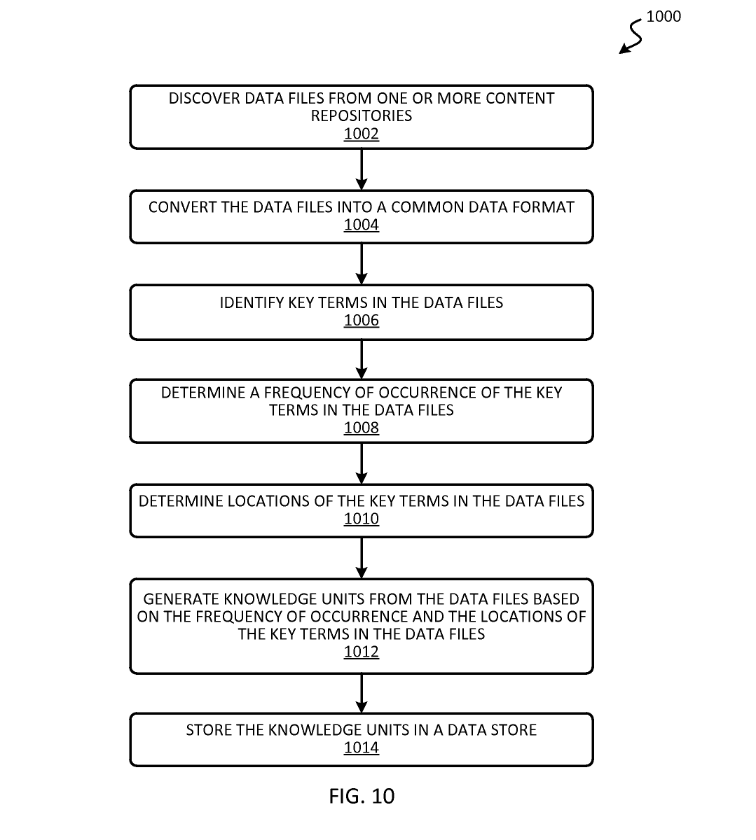

FIG. 10 illustrates a flow diagram of a content discovery and ingestion process 1000 that can be performed by a knowledge automation system, according to some embodiments. Process 1000 may begin at block 1002 by discovering data files from one or more content repositories. The data files can be discovered, for example, by crawling or mining one or more content repositories accessible by the knowledge automation system. In some embodiments, the data files can also be discovered by monitoring the one or more content repositories to detect addition of new content or modifications being made to content stored in the one or more content repositories.

At block 1004, the discovered data files can be converted into a common data format. For example, documents and images can be converted into a portable document format, and optical character recognition can be performed on the data files to identify text contained in the data files. Audio files can be transcribed, and the transaction text can be converted into the portable document format. Video files can also be converted into a series of images, and the series of images can be converted into the portable document format.

At block 1006, process 1000 may identify key terms in the discovered data files. A key term may be a key word or a key phrase. In some embodiments, a key term may refer to an entity such as a person, a company, an organization, etc. A word or a phrase can be identified as being a key term, for example, if that term is repeatedly used in the content of the data file. In some embodiments, a minimum threshold number of occurrences (e.g., five occurrences) can be set, and terms appearing in the data file more than the minimum threshold number of occurrences can be identified as a key term. In some embodiments, metadata associated with the data file can also be identified as a key term. For example, a word or a phrase in the title or the filename of the data file can be identified as a key term.

At block 1008, for each of the identified key terms, the frequency of occurrence of the key term in the corresponding data file is determined. The frequency of occurrence of the key term can be a count of the number of times the key term appears in the data file. In some embodiments, depending on where the key term appears in the data file, the occurrence of the key term can be given additional weight. For example, a key term appearing in the title of a data file can be counted as two occurrences. In some embodiments, pronouns or other words that are used as a substitute for a key term can be identified and correlated back to the key term to be included in the count.

At block 1010, for each of the identified key terms, the location of each occurrence of the key term is determined. In some embodiments, the location can be represented as an offset from the beginning of the document to where the key term appears. For example, the location can be represented as a word count from the beginning of the document to the occurrence of the key term. In some embodiments, page numbers, line numbers, paragraph numbers, column numbers, grid coordinates, etc., or any combination thereof can also be used.

At block 1012, process 1000 generates knowledge units from the data files based on the determined frequencies of occurrence and the determined locations of the key terms in the data files. In some embodiments, knowledge units can be generated for a predetermined number of the most frequently occurring key terms in the data file, or key terms with a frequency of occurrence above a predetermined threshold number in the data file. By way of example, the first and last occurrences of the key term can be determined, and the portion of the data file that includes the first and last occurrences of the key term can be extracted and formed into a knowledge unit. In some embodiments, a statistical analysis of the distribution of the key term in the data file can be used to extract the most relevant portions of the data file relating to the key term. For example, different portions of the data file having a concentration of the key term being above a threshold count can be extracted, and these different sections can be combined into a knowledge unit. The portions being combined into a knowledge unit may include sequential portions and/or non-sequential portions. Thus, a data file can be segmented into separate portions or knowledge segments, and one or more of the knowledge units can be formed by combining the different portions or knowledge segments. For a data file that includes unstructured content, and the data file can be segmented based on the locations of the occurrences of the key terms in the data file. For structured data files, the segmentation can be performed based on the organization of the data file (e.g., segment at the end of paragraphs, end of sections, etc.). It should be noted that in some embodiments, a knowledge unit can also be formed from an entire data file.

At block 1014, process 1000 may store the generated knowledge units in a data store (e.g., a knowledge bank). In some embodiments, each knowledge unit can be assigned a knowledge unit identifier that can be used to reference the knowledge unit in the data store. Each of the knowledge units can also be associated with a term vector that includes one or more key terms associated with the corresponding knowledge unit. Additional information that can be included in the term vector may include metadata such as author or source of the knowledge unit, location of where the knowledge unit is stored in the one or more content repositories, derived metadata such as the topic or topics associated with the knowledge unit, etc.

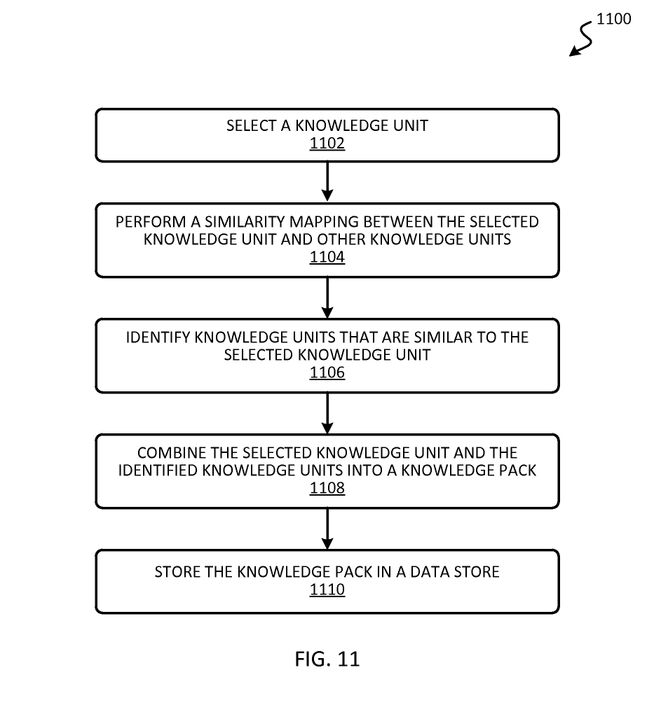

FIG. 11 illustrates a flow diagram of a content analysis process 1100 that can be performed by a knowledge automation system on the generated knowledge units, according to some embodiments. Process 1100 may begin at block 1102 by selecting a generated knowledge unit. The knowledge unit can be selected, for example, by an iterative process, randomly, or as a new knowledge unit is generated.

At block 1104, process 1100 performs a similarity mapping between the selected knowledge unit and the other knowledge units available in the knowledge bank. Process 1100 may use a knowledge unit distance metric, such as a Euclidean distance computation, to determine the amount of similarity between the knowledge units. By way of example, the term vector associated with each knowledge unit can be modeled as a n-dimensional vector, and the Euclidean distance in n-dimensional space between the end points of the vectors representing the knowledge units can be used to represent the amount of similarity between the knowledge units.

At block 1106, one or more knowledge units that are similar to the selected knowledge unit can be identified. For example, a knowledge unit can be identified as being similar to the selected knowledge unit if the knowledge unit distance metric (e.g., Euclidean distance) between that knowledge unit and the selected knowledge unit is below a predetermined threshold distance. In some embodiments, this threshold distance can be adjusted to adjust the number of similar knowledge units found.

At block 1108, the selected knowledge unit and the identified one or more similar knowledge units can be combined and formed into a knowledge pack. The knowledge pack can then be stored in a data store (e.g., a knowledge bank) at block 1110 for consumption by a knowledge consumer. In some embodiments, each knowledge pack can be assigned a knowledge pack identifier that can be used to reference the knowledge unit in the data store. Each of the knowledge packs can also be associated with a term vector that includes one or more key terms associated with the corresponding knowledge pack. In some embodiments, because a knowledge pack may have a large number of key terms, the key terms included in the knowledge pack term vector can be limited to a predetermined number of the most frequently occurring key terms (e.g., top twenty key terms, top fifty key terms, etc.). Additional information that can be included in the term vector may include metadata and derived metadata such as the topic or topics associated with the knowledge pack, a category that the knowledge pack belongs to, etc.

### III. Knowledge Brokering and Knowledge Campaigns

In traditional training and learning environments, relevant training materials are manually defined by a supervisor or an instructor. This can lead to inconsistent results, such as conflicting or inadequate information disseminated by different supervisors or instructors. Furthermore, for information disseminated to users via a computer network (e.g., web-based training materials), it can be difficult to track the progress of how much material each user has gone through. In some embodiments, the knowledge automation system can be used to automatically generate a knowledge campaign covering a particular topic by gathering the appropriate knowledge elements (e.g., knowledge units and/or knowledge packs) to disseminate to target users of the system. Because the knowledge campaign is automatically generated by the knowledge automation system, given a knowledge corpus and a proper description of the knowledge campaign, the knowledge automation system can consistently create a knowledge campaign with the appropriate materials. In some embodiments, as target users view and consume a knowledge campaign, the consumption progress of the target users can be monitored and tracked. The knowledge automation system can display the consumption progress of a knowledge campaign on a graphical user interface such that the creator or publisher of the knowledge campaign can easily determine how much of the knowledge campaign has been consumed and by which target user.

For example, when a new product is about to be launched, a manager or a supervisor may want to compile training materials on the new product to train the sales team and a technical support staff. Instead of requiring the manager or supervisor to contact different departments and employees to obtain the necessary information and to manually compile the information into a usable form, the knowledge automation system can analyze a textual description of the knowledge campaign (e.g., a description of the new product being launched), access the knowledge bank of the enterprise to retrieve knowledge elements relevant to the new product, and automatically compile the relevant knowledge elements into a knowledge campaign. The knowledge automation system can push the generated knowledge campaign to personnel on the sales team and technical support staff, and notify these target users that a knowledge campaign has been made available them. As each user accesses the knowledge automation system to consume the materials in the knowledge campaign, the consumption progress can be monitored based on how much of the knowledge campaign has been viewed by a target user and how long a target user has spent on each portion of the knowledge campaign. A summary of the consumption information can be presented to the manager or supervisor on a graphical user interface such that the manage or supervisor can easily track the progress of the knowledge campaign.

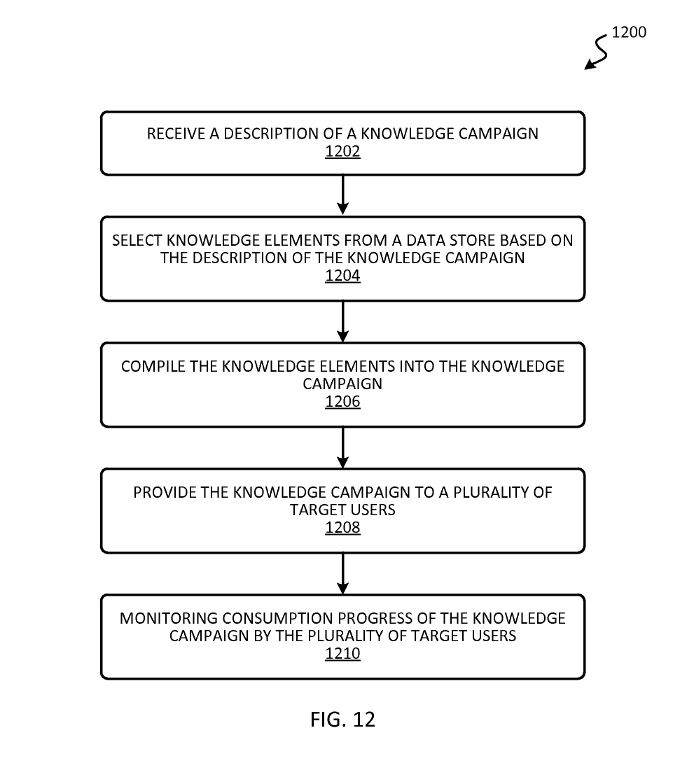

FIG. 12 illustrates a flow diagram of a knowledge campaign generation process 1200 that can be performed by a knowledge automation system (e.g., knowledge automation system 100 or 300), according to some embodiments. Process 1200 may begin at block 1202 by receiving a description of a knowledge campaign that a knowledge campaign creator wants to generate. In some embodiments, the knowledge campaign creator may submit a textual description of the materials that the creator wants the knowledge campaign to cover to the knowledge automation system on a knowledge campaign creator user interface. The textual description can be, for example, a summary sentence or paragraph describing the content, purpose, or goal of the knowledge campaign. In some embodiments, the textual description can be one or more key terms (e.g., key words and/or key phrases). As an example, if the purpose of the knowledge campaign is to train users on a new product, the name of model number of the product can be used as the description of a knowledge campaign for submission to the knowledge automation system. In some embodiments, the knowledge campaign creator can also specify a campaign title to identify the knowledge campaign, the start and end dates of the knowledge campaign indicating the duration of time of when the knowledge campaign will be available (e.g., the knowledge campaign can be scheduled to be made available at a future date), and the target users that the knowledge campaign should be made available to. In some embodiments, the knowledge automation system can also automatically determine target users that may be interest in the knowledge campaign based on user interest patterns in the user profiles.

At block 1204, process 1200 may automatically select knowledge elements (e.g., knowledge units and/or knowledge packs) from a data store based on the description of the knowledge campaign. For example, the knowledge automation system may analyze and parse the description of the knowledge campaign to identify key terms used in the description that matches key terms in the knowledge corpus. If just one key term is provided or identified, the knowledge automation system may access a data store (e.g., a knowledge bank) and retrieve knowledge elements most relevant to that key term. For example, a top number of knowledge elements with the highest frequency of occurrence of the key term can be retrieved (e.g., top ten knowledge elements with the highest frequency of occurrence), or knowledge elements in which the key term appears more than a threshold amount of times can be retrieved (e.g., knowledge elements which has more than five occurrences of the key term). If the description of the knowledge campaign includes multiple key terms, the same analysis can be performed for each key term in the description. Additionally or alternatively, a term vector of key terms can be generated for the knowledge campaign, and the relevant knowledge elements can be determined using a distance metric between the term vector of the knowledge campaign description and the term vector of each knowledge element. The distance metric can be, for example, a n-dimensional Euclidian distance between the two term vectors, and knowledge elements that have a term vector distance below a threshold can be identified as being relevant and be selected for inclusion in the knowledge campaign.

In some embodiments, the knowledge automation system may also perform automated knowledge brokering by identifying experts who may be knowledgeable in the subject area being covered by the knowledge campaign, such that the knowledge campaign creator or the knowledge automation system can contact the identified experts to provide addition content or materials for the knowledge campaign. This knowledge brokering can be performed, for example, when the knowledge automation system is unable to find sufficient amount of relevant knowledge elements presently available in the knowledge bank. The experts can be identified by identifying knowledge publishers who have published knowledge elements to the system in the same or similar topic, or knowledge consumers who have consumed knowledge elements in the same or similar topic. When the experts publish relevant knowledge elements to the system, the newly added knowledge elements can be added to the knowledge campaign.

At block 1206, process 1200 may generate the knowledge campaign from the selected knowledge elements. For example, the knowledge automation system may compile the selected knowledge elements into a knowledge campaign. For knowledge units that have been selected as being relevant to the knowledge campaign, the complication process may involve, for each knowledge unit, identifying one or more knowledge packs that the knowledge unit is part of, and adding the identified knowledge packs to the knowledge campaign. If a selected knowledge unit is not part of any knowledge pack, the knowledge unit itself can be added to the knowledge campaign. In some embodiments, the same knowledge element can be identified as being relevant to the knowledge campaign multiple times (e.g., based on analyses using different key terms from the knowledge campaign description). In such scenarios, duplicate knowledge elements can be removed such that the knowledge element is added to the knowledge campaign only once. In some embodiments, the creator of the knowledge campaign may also manually remove knowledge elements automatically selected by the knowledge automation system, or add knowledge elements that the knowledge automation system did not select.

At block 1208, the knowledge automation system may provide the generated knowledge campaign to a set of target users. The set of target users can be users identified by the knowledge campaign creator. In some embodiments, the set of target user may also include users that the knowledge automation system automatically identified as someone who would be interested in the knowledge campaign based on user interest patterns learned by the knowledge automation system. The knowledge campaign can be pushed to the target users by presenting an icon or other graphical element that represents the knowledge campaign on a user interface that is displayed when the target user signs in to knowledge automation system, or by sending a notification to the target user to indicate that a knowledge campaign has been made available. In some embodiments, the knowledge campaign creator can specify a start date of the knowledge campaign indicating when the knowledge campaign will be pushed out to the target users. The knowledge campaign creator can also specify an end date, after which the knowledge campaign will no longer be available to the target user.

At block 1210, the knowledge automation system may monitor the consumption progress of the knowledge campaign by the target users. For example, the knowledge campaign, which may include a number of knowledge elements, can be organized into sections or pages. As each user traverses through the knowledge campaign by viewing the content on the knowledge automation system, the system may monitor how many pages or up to which section the target user has viewed or read. In some embodiments, to prevent a target user from simply clicking through the materials, the amount of time the target user spends on a particular section or page can be tracked, and the particular section or page is determined to have been consumed by the target user only when the target user has spent over a threshold amount of time viewing that section or page. In some embodiments, the threshold amount of time for each section or page can be varied and adjusted based on the amount of content in that section or page, and/or the complexity of the materials in that section or page. The number of sections or pages consumed by the target user can be used to derive a proficiency percentage of the target user on the knowledge campaign. For example, if the knowledge campaign includes 60 pages of material, and the target user has consumed 20 pages of material, the target user may have a 33% proficiency on the knowledge campaign.

Other information that can be tracked by the knowledge automation system may include the number of times each knowledge element of the knowledge campaign has been viewed, how many of the target users have viewed each knowledge element of the knowledge campaign, and the last time that each target user has accessed the knowledge campaign, etc. In some embodiments, the target users may belong to one or more user groups (e.g., employees of certain department can be grouped together as a user group). The knowledge automation system may also derive consumption progress of each user group by aggregating the consumption progress of the individual target users of each user group. In some embodiments, consumption progress statistics can be presented to a user (e.g., the knowledge campaign creator, administrator, manager, or supervisor, etc.) on a graphical user interface such that the user can easily determine how much of the content in the knowledge campaign has been consumed.

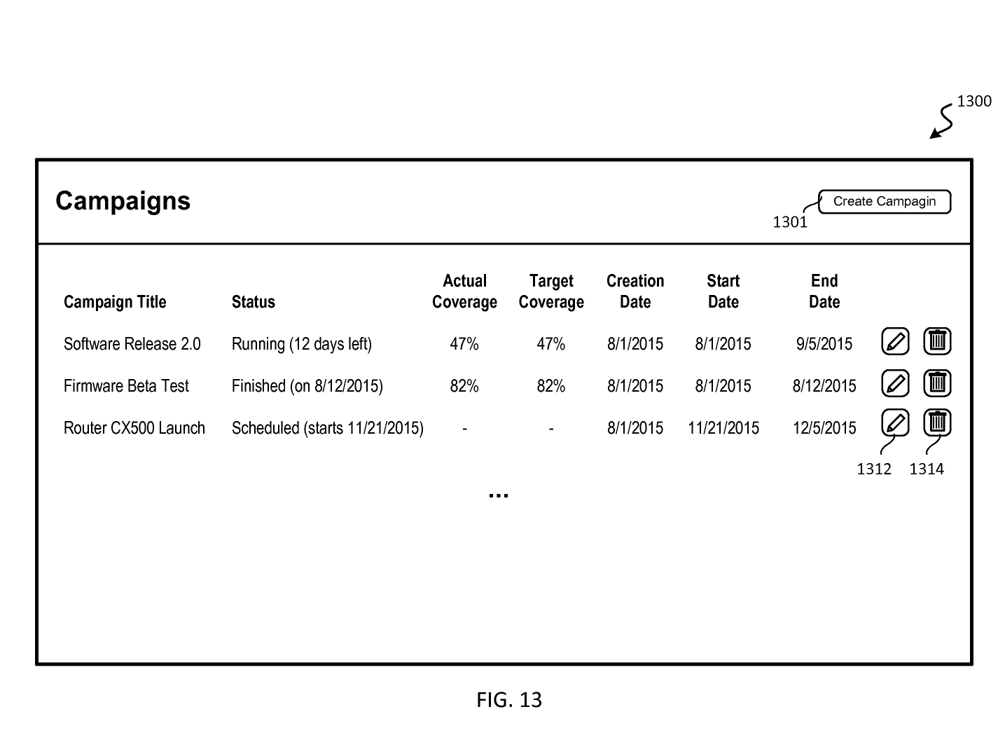

FIG. 13 illustrates a graphical user interface 1300 for displaying a list of knowledge campaigns, according to some embodiments. Graphical user interface 1300 may display a summary listing of the knowledge campaigns created by a particular user, by users of a user group, or by users of an enterprise. For example, graphical user interface 1300 may display, for each knowledge campaign that has been created, information associated with the knowledge campaign such as a campaign title, a status of the knowledge campaign, actual coverage of the knowledge campaign, target coverage of the knowledge campaign, a creation date of the knowledge campaign, a start date of the knowledge, and an end date of the knowledge campaign. In some embodiments, graphical user interface 300 may also display, for each knowledge campaign, an edit button 1312 or other graphical element that a user can select (e.g., click on) to edit the information about the particular knowledge campaign, and/or a delete button 1314 or other graphical element that a user can select (e.g., click) to remove the knowledge campaign from being displayed on graphical user interface 300.

The campaign title (may also be referred to as a campaign name) can be an identifier provided by the creator of knowledge campaign which is used to identify the particular knowledge campaign. In some embodiments, the campaign title can be automatically derived by the knowledge automation system based on the most frequently used key term in the campaign description. The status of the knowledge campaign may indicate whether the knowledge campaign is currently running (e.g., target users can access the knowledge campaign to consume content in the knowledge campaign), finished (e.g., the knowledge campaign is no longer available to target users), or is scheduled to start at a future date (e.g., the knowledge campaign will be available at the future date).

The actual coverage of the knowledge campaign may indicate how many users have viewed or access the knowledge campaign. In some embodiments, the actual coverage can be represented as a percentage of the total users that have accessed or viewed the knowledge campaign. The total users can be the number of users in a user group, the number of users in multiple user groups, or the number of users in the enterprise. The target coverage of the knowledge campaign may indicate how many users of the total users have been targeted with the knowledge campaign. In some embodiments, the target coverage can be represented as a percentage of the total users. For example, if an enterprise has 500 users, and 450 users have been targeted by the knowledge campaign, the target coverage can be 90%. In some embodiments, the success of the knowledge campaign can be indicated by the difference between the actual coverage and the target coverage.

The creation date indicates when the knowledge campaign was created. The start date indicates when the knowledge campaign was first made available to the target users, and the end date indicates when the knowledge campaign will no longer be available for target users to consume. In some embodiments, the knowledge campaign can still be made available after the end date, but the knowledge automation system may stop monitoring consumption progress of the knowledge campaign after the end date.

Graphical user interface 1300 may also display a create campaign button 1301 or other graphical element that a user can select (e.g., click on) to allow the user to create a new knowledge campaign. Upon selecting the create campaign button 1301, a popup screen or another page can be displayed to allow a user to enter a description of the knowledge campaign that the user wants to create and other information about the knowledge campaign such as a start date, an end date, and target users of the knowledge campaign, etc. When a new knowledge campaign is created, the knowledge campaign can be added to the listing on the graphical user interface 1300.

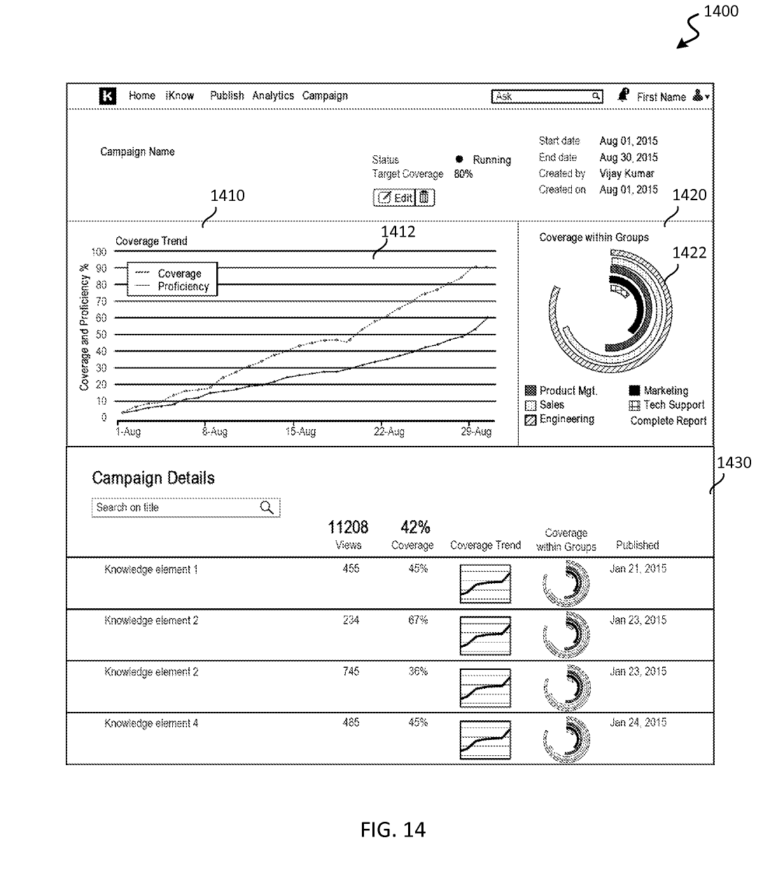

FIGS. 14-18 illustrate various graphical user interfaces for displaying consumption progress information of a knowledge campaign. It should be understood that the specific content in the figures are for illustrative purposes, and that certain graphical elements may not necessary be drawn to scale. Furthermore, in the following description, some graphical elements may be described as representing numeric values or percentages. It should be understood that the graphical elements shown in the figures are drawn for illustrative purposes and may not necessary match their corresponding numeric values or percentages shown in the figures.

Graphical user interface 1400 can be accessed, for example, by selecting (e.g., clicking on) a knowledge campaign title on the summary listing of graphical user interface 1300. Graphical user interface 1400 may display, in a header section, knowledge campaign information such as the campaign title, current status of the knowledge campaign, target coverage of the knowledge campaign, start date, end date, creation date, and the creator of the knowledge campaign.

FIG. 14 illustrates a graphical user interface 1400 for displaying consumption progress of a knowledge campaign, according to some embodiments. Graphical user interface 1400 can be accessed, for example, by selecting (e.g., clicking on) a knowledge campaign title on the summary listing of graphical user interface 1300. Graphical user interface 1400 may display, in a header section, knowledge campaign information such as the campaign title, current status of the knowledge campaign, target coverage of the knowledge campaign, start date, end date, creation date, and the creator of the knowledge campaign.

In some embodiments, graphical user interface 1400 may include a first area 1410 in which a graphical element 1412 representing an aggregated consumption trend of the knowledge campaign over time is displayed. The aggregated consumption trend may include information about the actual coverage of the knowledge campaign over time (e.g., how many users have viewed the knowledge campaign over time). The actual coverage can be, for example, a percentage of the total users that have viewed the knowledge campaign. The aggregated consumption trend may also include information about the proficiency of users of the content covered by the knowledge campaign over time (e.g., amount of content consumed by the users). In some embodiments, the proficiency can be represented as how many users of the total users have completed consumption of all materials in the knowledge campaign. Thus, for example, if there are 100 total users, 10 target users have consumed half of the content in the knowledge campaign, and 20 target users have consumed all content in the knowledge campaign, the proficiency can be 20%, since 20 of 100 total users have consumed all content in the knowledge campaign. In some embodiments, the proficiency can take into account partial consumption of the content in the knowledge campaign. Thus, for example, if there are 100 total users, 10 target users have consumed half of the content in the knowledge campaign, and 20 target users have consumed all content in the knowledge campaign, the proficiency can be 25%, since 20 of 100 total users have consumed 100% of the content and 10 users have consumed 50% of the content. In other words, in some embodiments, the proficiency can be represented as a sum of the user consumption percentages over the total users. The aggregated consumption trend information (e.g., actual coverage, proficiency) over a time period can be displayed to show the trend of how target users are consuming the knowledge campaign. The time period displayed can span from the start date of the knowledge campaign to the end date of the knowledge campaign, or a portion thereof. In some embodiments, the aggregated consumption trend information (e.g., actual coverage, proficiency) can be displayed as line graphs, bar graphs, or other graphical representations or charts, etc.

Graphical user interface 1400 may also include a second area 1420 in which a graphical element 1422 is displayed. Graphical element 1422 may represent, for one or more user groups, coverage information about the target users in each user group. In other words, graphical element 1422 may indicate coverage information at the user group level. In some embodiments, the coverage information can be the actual coverage (e.g., the number or percentage of target users in each user group that has viewed the knowledge campaign), or can be the target coverage (e.g., the number or percentage of target users in each user group for which the knowledge campaign has been provided to). In some embodiments, graphical element 1422 may include a set of concentric circular lines or bars, wherein each concentric circular line or bar represents one user group, and a length of the concentric circular line or bar represents the coverage information of the corresponding user group (e.g., number or percentage of the target users in the corresponding user group that has viewed the knowledge campaign or has been targeted with the knowledge campaign). Different user groups can also be displayed in different colors or fill patterns to distinguish one user group from another. The coverage information for each user group can also be displayed as line graphs, bar graphs, or other graphical representations or charts, etc.

Graphical user interface 1400 may further include a third area 1430 in which consumption information for each of one or more of the knowledge elements in the knowledge campaign is displayed. In other words, consumption information at the knowledge element level can be displayed in the third area 1430. For example, the consumption information displayed for each knowledge element may include the number of views, the actual or target coverage of the particular knowledge element, a graphical representation of the coverage trend for the particular knowledge element, a graphical representation of the coverage information (e.g., actual or target coverage) for the particular knowledge element per user group, and the publication date of the knowledge element. In some embodiments, an aggregated number of views and aggregated coverage information (e.g., actual or target coverage) can also be displayed in the third area 1430.

Accordingly, graphical user interface 1400 can provide a compressive view of the consumption progress of a knowledge campaign that a user (e.g., the knowledge campaign creator, administrator, manager, or supervisor, etc.) can easily digest. Graphical user interface 1400 may provide aggregate consumption trend across all users, coverage information at the user group level, and consumption information at the knowledge element level. A user viewing graphical user interface 1400 can easily determine how well each user group is consuming the knowledge campaign, and which knowledge element is well-consumed. In some embodiments, a user viewing graphical user interface 1400 may also interact with the graphical user interface 1400 to access different breakdowns of the consumption progress information.

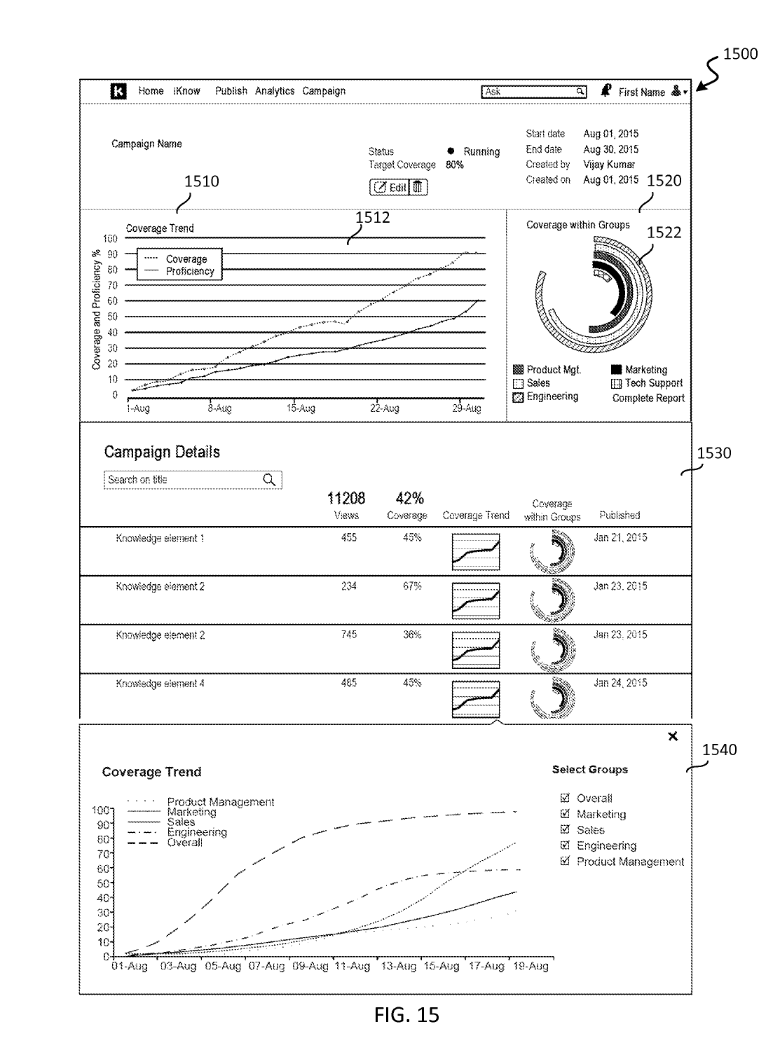

For example, FIG. 15 illustrates a graphical user interface 1500 for displaying consumption trends of a knowledge campaign by user groups, according to some embodiments. When a user selects (e.g., clicks on) the first area 1510 displaying graphical element 1512 representing the aggregated consumption trend of the knowledge campaign over time, in response to detecting the user selection of the first area 1510, graphical user interface 1500 may display, in a fourth area 1540, a list of user groups and a consumption trend of the knowledge campaign for each of one or more of the user groups. In other words, a user can select the first area 1510 to breakdown the aggregated consumption trend into consumption trend by user groups. The consumption trends displayed in the fourth area 1540 can be the actual coverage per user group over time, and/or the proficiency per user group over time. Each use group can be displayed using a different color or fill patterns to distinguish one user group from another.

In some embodiments, a user can also select which user group is displayed in the fourth area 1540. For example, when user selection of a user group on the list of user groups whose consumption trend is not currently displayed in the fourth area 1540 is detected, graphical user interface 1500 can add the consumption trend of the selected user group to the consumption trends being displayed in the fourth area 1540. When user selection of a user group on the list of user groups whose consumption trend is currently displayed in the fourth area 1540 is detected, graphical user interface 1500 can remove the consumption trend of the deselected user group from the consumption trends being displayed in the fourth area 1540. In this manner, a user can selectively choose the consumption trend of which user group to display in the fourth area 1540.

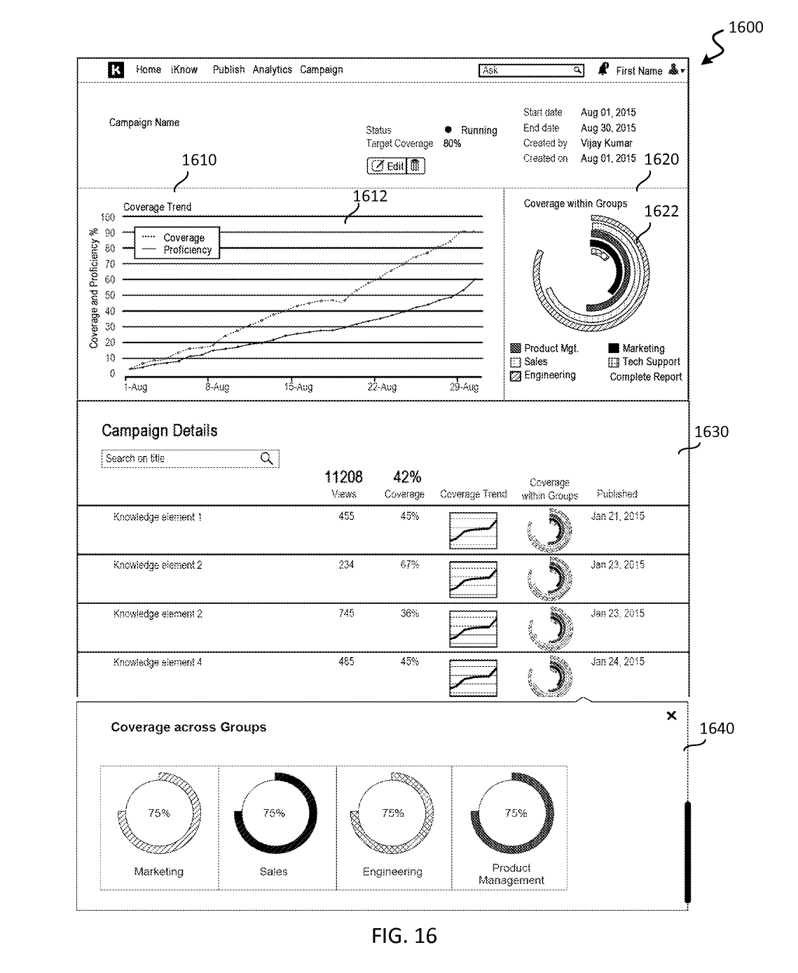

FIG. 16 illustrates a graphical user interface 1600 for displaying expanded coverage information per user group, according to some embodiments. When a user selects (e.g., clicks on) the second area 1620 displaying graphical element 1622 representing coverage information for the user groups, in response to detecting the user selection of the second area 1620, graphical user interface 1600 may display, in a fourth area 1640, multiple tiles where each tile represents on user group and each tile displays coverage information (e.g., actual coverage, target coverage) for that one user group. This allows a user to easily separate and distinguish the coverage information for one user group from the other user groups. In some embodiments, similar to graphical element 1622, the coverage information for a user group can be displayed as a circular line or bar where the length of the circular line or bar represents the coverage information of the corresponding user group (e.g., number or percentage of the target users in the corresponding user group that has viewed the knowledge campaign or has been targeted with the knowledge campaign). In some embodiments, the coverage information displayed for each user group in the fourth area 1640 can also be displayed as a line graph, a bar graph, or other graphical representations or charts, etc. In some embodiments, the coverage information in the fourth area 1640 can also be displayed in a format that is different than graphical element 1622.

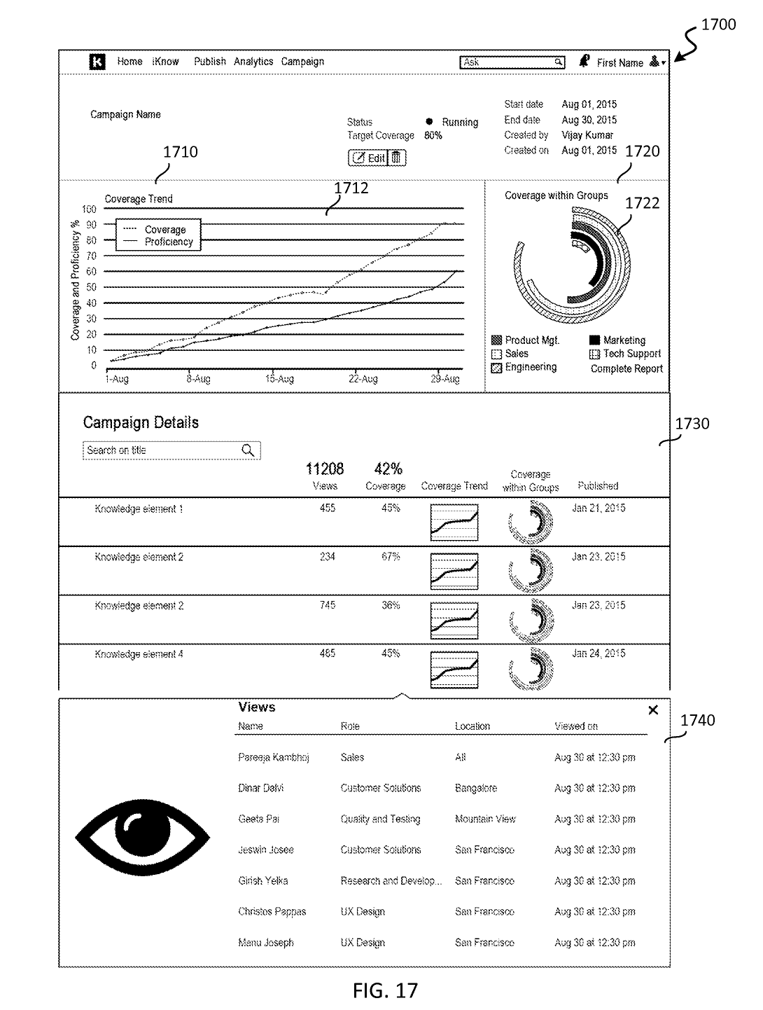

FIG. 17 illustrates a graphical user interface 1700 for displaying consumption information of a knowledge element in the knowledge campaign at the user level, according to some embodiments. When a user selects (e.g., clicks on) consumption information for a particular knowledge element in the third area 1730, in response to detecting the user selection of the consumption information for that knowledge element, graphical user interface 1700 may display, in a fourth area 1740, consumption information of that knowledge element by each of one or more of the target users. In other words, the fourth area 1740 may display consumption information for a knowledge element at the user level. For example, when a user selects (e.g., clicks on) the number of views of a knowledge element in the third area 1730, graphical user interface 1700 may display, in the fourth area 1740, the date and time that the knowledge element was last viewed by each target user. The fourth area 1740 may also display addition information about each target user such as the role of the target user and the location of the target user.

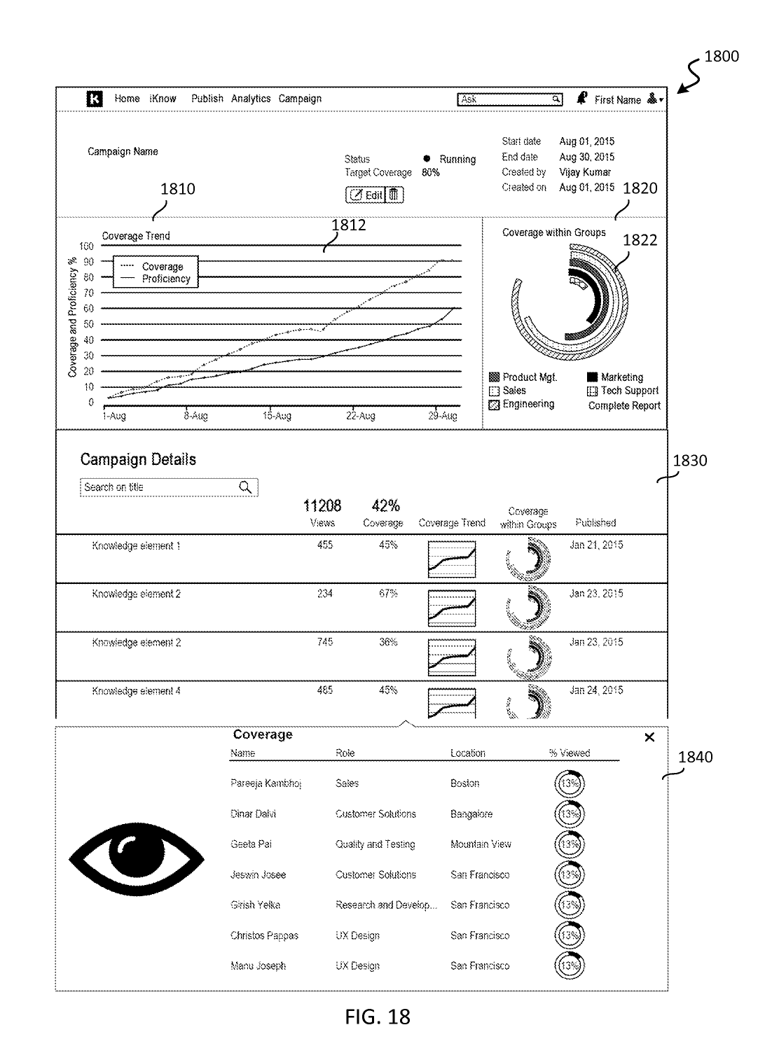

FIG. 18 illustrates another graphical user interface 1800 for displaying consumption information of a knowledge element in the knowledge campaign at the user level, according to some embodiments. When a user selects (e.g., clicks on) the coverage information of a knowledge element in the third area 1830, graphical user interface 1800 may display, in the fourth area 1740, the percentage of the knowledge element that each target user has consumed. For example, the percentage consumed can be based on the percentage of pages of the knowledge element that the user has consumed. This allows a user (e.g., the knowledge campaign creator, administrator, manager, or supervisor, etc.) to easily obtain consumption progress of each knowledge element in the knowledge campaign down to the user level.

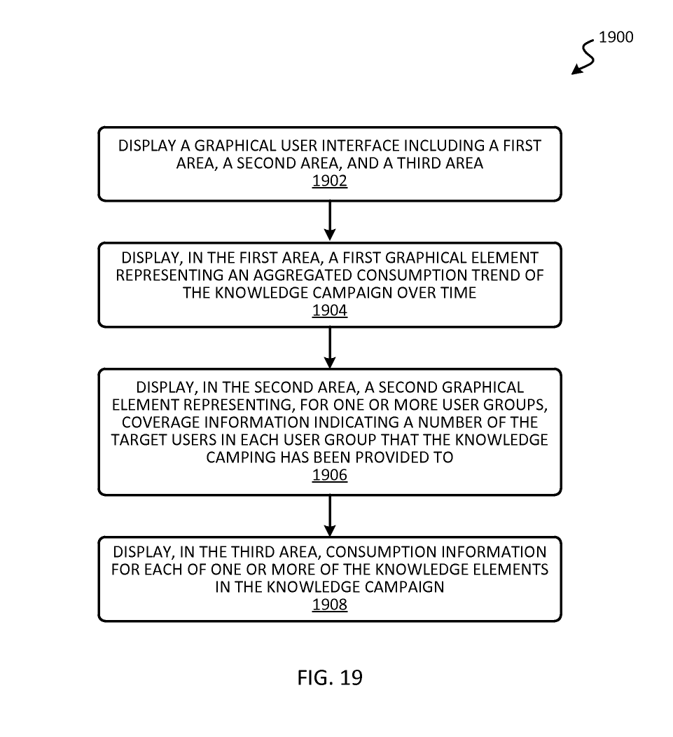

FIG. 19 illustrates a flow diagram of a process 1900 that can be performed by a knowledge automation system (e.g., knowledge automation system 100 or 300) for displaying consumption progress information of a knowledge campaign on a graphical user interface, according to some embodiments. Process 1900 may begin at block 1902 by displaying a graphical user interface including a first area, a second area, and a third area. At block 1904, process 1900 may display in the first area, a first graphical element representing an aggregated consumption trend of the knowledge campaign over time. At block 1906, process 1900 may display, in the second area, a second graphical element representing, for one or more user groups, coverage information about the target users in each user group. At block 1908, process 1900 may display, in the third area, consumption information for each of one or more of the knowledge elements in the knowledge campaign.

In some embodiments, in response to detecting user selection of the first area, a list of user groups and a consumption trend of the knowledge campaign for each of one or more of the user groups can be displayed in a fourth area of the graphical user interface. When user deselection of a user group on the list of user groups whose consumption trend is being displayed in the fourth area is detected, the consumption trend of the deselected user group can be removed from the fourth area. When user selection of a user group on the list of user groups whose consumption trend is not being displayed in the fourth area is detected, display of the consumption trend of the selected user group can be added to the fourth area.

In some embodiments, in response to detecting the user selection of the second area, multiple tiles can be displayed in a fourth area of the graphical user interface. Each tile may correspond to a user group, and each tile may display the coverage information of the corresponding user group. In some embodiments, in response to detecting the user selection of the consumption information of a knowledge element in the third area, consumption information of the corresponding knowledge element by each of one or more of the target users can be displayed in a fourth area of the graphical user interface.

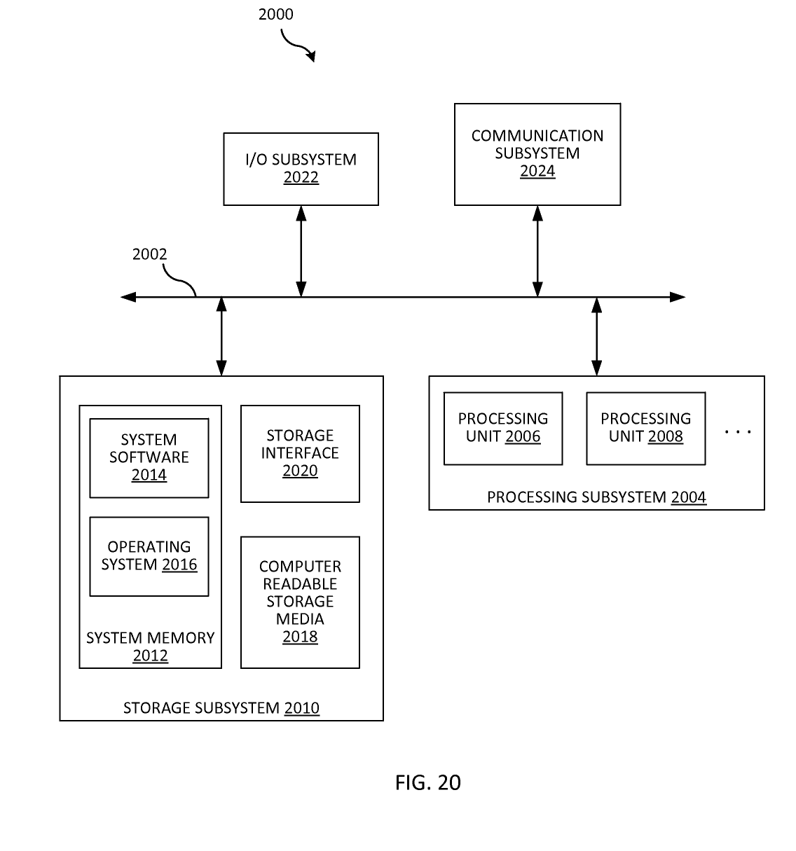

FIG. 20 depicts a block diagram of a computing system 2000, in accordance with some embodiments. Computing system 2000 can include a communications bus 2002 that connections one or more subsystems, including a processing subsystem 2004, storage subsystem 2010, I/O subsystem 2022, and communication subsystem 2024.

In some embodiments, processing subsystem 2008 can include one or more processing units 2006, 2008. Processing units 2006, 2008 can include one or more of a general purpose or specialized microprocessor, FPGA, DSP, or other processor. In some embodiments, processing unit 2006, 2008 can be a single core or multicore processor.

In some embodiments, storage subsystem can include system memory 2012 which can include various forms of non-transitory computer readable storage media, including volatile (e.g., RAM, DRAM, cache memory, etc.) and non-volatile (flash memory, ROM, EEPROM, etc.) memory. Memory may be physical or virtual. System memory 2012 can include system software 2014 (e.g., BIOS, firmware, various software applications, etc.) and operating system data 2016. In some embodiments, storage subsystem 2010 can include non-transitory computer readable storage media 2018 (e.g., hard disk drives, floppy disks, optical media, magnetic media, and other media). A storage interface 2020 can allow other subsystems within computing system 2000 and other computing systems to store and/or access data from storage subsystem 2010.

In some embodiments, I/O subsystem 2022 can interface with various input/output devices, including displays (such as monitors, televisions, and other devices operable to display data), keyboards, mice, voice recognition devices, biometric devices, printers, plotters, and other input/output devices. I/O subsystem can include a variety of interfaces for communicating with I/O devices, including wireless connections (e.g., Wi-Fi, Bluetooth, Zigbee, and other wireless communication technologies) and physical connections (e.g., USB, SCSI, VGA, SVGA, HDMI, DVI, serial, parallel, and other physical ports).

In some embodiments, communication subsystem 2024 can include various communication interfaces including wireless connections (e.g., Wi-Fi, Bluetooth, Zigbee, and other wireless communication technologies) and physical connections (e.g., USB, SCSI, VGA, SVGA, HDMI, DVI, serial, parallel, and other physical ports). The communication interfaces can enable computing system 2000 to communicate with other computing systems and devices over local area networks wide area networks, ad hoc networks, mesh networks, mobile data networks, the internet, and other communication networks.

In certain embodiments, the various processing performed by a knowledge modeling system as described above may be provided as a service under the Software as a Service (SaaS) model. According this model, the one or more services may be provided by a service provider system in response to service requests received by the service provider system from one or more user or client devices (service requestor devices). A service provider system can provide services to multiple service requestors who may be communicatively coupled with the service provider system via a communication network, such as the Internet.

In a SaaS model, the IT infrastructure needed for providing the services, including the hardware and software involved for providing the services and the associated updates/upgrades, is all provided and managed by the service provider system. As a result, a service requester does not have to worry about procuring or managing IT resources needed for provisioning of the services. This significantly increases the service requestor's access to these services in an expedient manner at a much lower cost point.

In a SaaS model, services are generally provided based upon a subscription model. In a subscription model, a user can subscribe to one or more services provided by the service provider system. The subscriber can then request and receive services provided by the service provider system under the subscription. Payments by the subscriber to providers of the service provider system are generally done based upon the amount or level of services used by the subscriber.

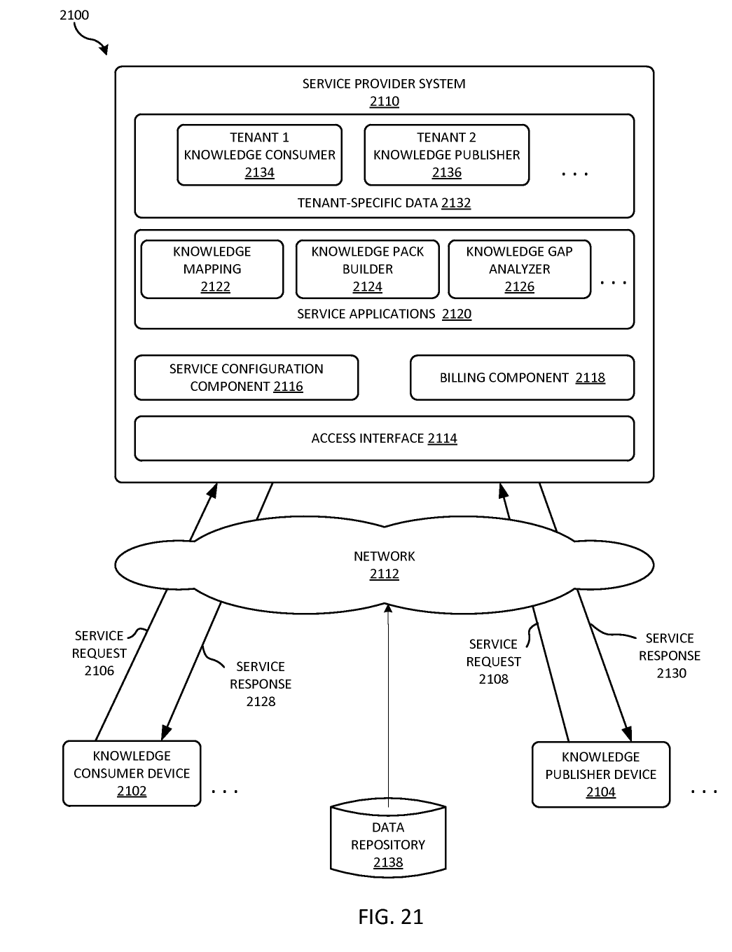

FIG. 21 depicts a simplified block diagram of a service provider system 2100, in accordance with some embodiments. In the embodiment depicted in FIG. 21, service requestor devices 2104 and 2104 (e.g., knowledge consumer device and/or knowledge publisher device) are communicatively coupled with service provider system 2110 via communication network 2112. In some embodiments, a service requestor device can send a service request to service provider system 2110 and, in response, receive a service provided by service provider system 2110. For example, service requestor device 2102 may send a request 2106 to service provider system 2110 requesting a service from potentially multiple services provided by service provider system 2110. In response, service provider system 2110 may send a response 2128 to service requestor device 2102 providing the requested service. Likewise, service requestor device 2104 may communicate a service request 2108 to service provider system 2110 and receive a response 2130 from service provider system 2110 providing the user of service requestor device 2104 access to the service. In some embodiments, SaaS services can be accessed by service requestor devices 2102, 2104 through a thin client or browser application executing on the service requestor devices. Service requests and responses 2128, 2130 can include HTTP/HTTPS responses that cause the thin client or browser application to render a user interface corresponding to the requested SaaS application. While two service requestor devices are shown in FIG. 21, this is not intended to be restrictive. In other embodiments, more or less than two service requestor devices can request services from service provider system 2110.

Network 2112 can include one or more networks or any mechanism that enables communications between service provider system 2110 and service requestor devices 2102, 2104. Examples of network 2112 include without restriction a local area network, a wide area network, a mobile data network, the Internet, or other network or combinations thereof. Wired or wireless communication links may be used to facilitate communications between the service requestor devices and service provider system 2110.

In the embodiment depicted in FIG. 21, service provider system 2110 includes an access interface 2114, a service configuration component 2116, a billing component 2118, various service applications 2120, and tenant-specific data 2132. In some embodiments, access interface component 2114 enables service requestor devices to request one or more services from service provider system 2110. For example, access interface component 2114 may comprise a set of webpages that a user of a service requestor device can access and use to request one or more services provided by service provider system 2110.

In some embodiments, service manager component 2116 is configured to manage provision of services to one or more service requesters. Service manager component 2116 may be configured to receive service requests received by service provider system 2110 via access interface 2114, manage resources for providing the services, and deliver the services to the requesting requesters. Service manager component 2116 may also be configured to receive requests to establish new service subscriptions with service requestors, terminate service subscriptions with service requestors, and/or update existing service subscriptions. For example, a service requestor device can request to change a subscription to one or more service applications 2122-2126, change the application or applications to which a user is subscribed, etc.).

Service provider system 2110 may use a subscription model for providing services to service requestors according to which a subscriber pays providers of the service provider system based upon the amount or level of services used by the subscriber. In some embodiments, billing component 2118 is responsible for managing the financial aspects related to the subscriptions. For example, billing component 2110, in association with other components of service provider system 2110, may be configured to determine amounts owed by subscribers, send billing statements to subscribers, process payments from subscribers, and the like.

In some embodiments, service applications 2120 can include various applications that provide various SaaS services. For example, one more applications 2120 can provide the various functionalities described above and provided by a knowledge modeling system.

In some embodiments, tenant-specific data 2132 comprises data for various subscribers or customers (tenants) of service provider system 2110. Data for one tenant is typically isolated from data for another tenant. For example, tenant 1's data 2134 is isolated from tenant 2's data 2136. The data for a tenant may include without restriction subscription data for the tenant, data used as input for various services subscribed to by the tenant, data generated by service provider system 2110 for the tenant, customizations made for or by the tenant, configuration information for the tenant, and the like. Customizations made by one tenant can be isolated from the customizations made by another tenant. The tenant data may be stored service provider system 2110 (e.g., 2134, 2136) or may be in one or more data repositories 2138 accessible to service provider system 2110.

It should be understood that the methods and processes described herein are exemplary in nature, and that the methods and processes in accordance with some embodiments may perform one or more of the steps in a different order than those described herein, include one or more additional steps not specially described, omit one or more steps, combine one or more steps into a single step, split up one or more steps into multiple steps, and/or any combination thereof.

It should also be understood that the components (e.g., functional blocks, modules, units, or other elements, etc.) of the devices, apparatuses, and systems described herein are exemplary in nature, and that the components in accordance with some embodiments may include one or more additional elements not specially described, omit one or more elements, combine one or more elements into a single element, split up one or more elements into multiple elements, and/or any combination thereof.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps. Various features and aspects of the above-described embodiments may be used individually or jointly.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter-process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific invention embodiments have been described, these are not intended to be limiting. Various modifications and equivalents are within the scope of the following claims. For example, one or more features from any embodiment may be combined with one or more features of any other embodiment without departing from the scope of the invention.

What is claimed is:

1. A method comprising:
receiving, by a data processing system, a description of a knowledge campaign;
selecting, by the data processing system, knowledge elements from a data store based on the description of the knowledge campaign;
compiling, by the data processing system, the knowledge elements into the knowledge campaign;
providing, by the data processing system, the knowledge campaign to a plurality of target users;
monitoring, by the data processing system, consumption progress of the knowledge campaign by the plurality of target users;
displaying, by the data processing system, a graphical user interface including a first area, a second area, and a third area;
displaying, in the first area, a first graphical element representing an aggregated consumption trend of the knowledge campaign over time;
displaying, in the second area, a second graphical element representing, for one or more user groups, coverage information about the target users in each user group; and
displaying, in the third area, consumption information for each of one or more of the knowledge elements in the knowledge campaign.

2. The method of claim 1, further comprising:
detecting user selection of the first area; and
in response to detecting the user selection of the first area, displaying, in a fourth area of the graphical user interface, a list of user groups and a consumption trend of the knowledge campaign for each of one or more of the user groups.

3. The method of claim 2, further comprising:
detecting, in the fourth area, user deselection of a user group on the list of user groups whose consumption trend is being displayed in the fourth area; and
removing the consumption trend of the deselected user group from the fourth area.

4. The method of claim 2, further comprising:
detecting, in the fourth area, user selection of a user group on the list of user groups whose consumption trend is not being displayed in the fourth area; and
displaying the consumption trend of the selected user group in the fourth area.

5. The method of claim 1, further comprising:
detecting user selection of the second area; and
in response to detecting the user selection of the second area, displaying, in a fourth area of the graphical user interface, a plurality of tiles, each tile displaying the coverage information of one of the user groups.

6. The method of claim 1, wherein the second graphical element comprises a set of concentric circular lines, wherein each concentric circular line represents one user group, and a length of the concentric circular line represents the coverage information of the corresponding user group.

7. The method of claim 1, further comprising:
detecting user selection of an object in the third area; and
in response to detecting the user selection of the consumption information of a knowledge element in the third area, displaying, in a fourth area of the graphical user interface, consumption information of the corresponding knowledge element by each of one or more of the target users.

8. A system comprising:
one or more processors; and
a memory coupled with and readable by the one or more processors, the memory configured to store a set of instructions which, when executed by the one or more processors, causes the one or more processors to:
receive a description of a knowledge campaign;
select knowledge elements from a data store based on the description of the knowledge campaign;
generate the knowledge campaign from the selected knowledge elements;
provide the knowledge campaign to a plurality of target users;
monitor consumption progress of the knowledge campaign by the plurality of target users;
display a graphical user interface including a first area, a second area, and a third area;
display, in the first area, a first graphical element representing an aggregated consumption trend of the knowledge campaign over time;
display, in the second area, a second graphical element representing, for one or more user groups, coverage information about the target users in each user group; and
display, in the third area, consumption information for each of one or more of the knowledge elements in the knowledge campaign.

9. The system of claim 8, wherein the set of instructions further comprises instructions which, when executed by the one or more processors, cause the one or more processors to:
detect user selection of the first area; and
in response to detecting the user selection of the first area, display, in a fourth area of the graphical user interface, a list of user groups and a consumption trend of the knowledge campaign for each of one or more of the user groups.

10. The system of claim 9, wherein the set of instructions further comprises instructions which, when executed by the one or more processors, cause the one or more processors to:
detect, in the fourth area, user deselection of a user group on the list of user groups whose consumption trend is being displayed in the fourth area; and
remove the consumption trend of the deselected user group from the fourth area.

11. The system of claim 8, wherein the set of instructions further comprises instructions which, when executed by the one or more processors, cause the one or more processors to:
detect, in the fourth area, user selection of a user group on the list of user groups whose consumption trend is not being displayed in the fourth area; and
display the consumption trend of the selected user group in the fourth area

12. The system of claim 8, wherein the set of instructions further comprises instructions which, when executed by the one or more processors, cause the one or more processors to:
detect user selection of the second area; and
in response to detecting the user selection of the second area, display, in a fourth area of the graphical user interface, a plurality of tiles, each tile displaying the coverage information of one of the user groups.

13. The system of claim 8, wherein the second graphical element comprises a set of concentric circular lines, wherein each concentric circular line represents one user group, and a length of the concentric circular line represents the coverage information of the corresponding user group.

14. The system of claim 8, wherein the set of instructions further comprises instructions which, when executed by the one or more processors, cause the one or more processors to:
detect user selection of an object in the third area; and
in response to detecting the user selection of the consumption information of a knowledge element in the third area, display, in a fourth area of the graphical user interface, consumption information of the corresponding knowledge element by each of one or more of the target users.

15. A non-transitory computer-readable storage memory storing a plurality of instructions executable by one or more processors, the plurality of instructions comprising:
instructions that cause the one or more processors to receive a description of a knowledge campaign;
instructions that cause the one or more processors to select knowledge elements from a data store based on the description of the knowledge campaign;
instructions that cause the one or more processors to generate the knowledge campaign from the selected knowledge elements;
instructions that cause the one or more processors to provide the knowledge campaign to a plurality of target users;
instructions that cause the one or more processors to monitor consumption progress of the knowledge campaign by the plurality of target users;
instructions that cause the one or more processors to display a graphical user interface including a first area, a second area, and a third area;
instructions that cause the one or more processors to display, in the first area, a first graphical element representing an aggregated consumption trend of the knowledge campaign over time;
instructions that cause the one or more processors to display, in the second area, a second graphical element representing, for one or more user groups, coverage about the target users in each user group; and
instructions that cause the one or more processors to display, in the third area, consumption information for each of one or more of the knowledge elements in the knowledge campaign.

16. The non-transitory computer-readable storage memory of claim 15, wherein the plurality of instructions further comprises:
instructions that cause the one or more processors to detect user selection of the first area; and
instructions that cause the one or more processors to, in response to detecting the user selection of the first area, display, in a fourth area of the graphical user interface, a list of user groups and a consumption trend of the knowledge campaign for each of one or more of the user groups.

17. The non-transitory computer-readable storage memory of claim 16, wherein the plurality of instructions further comprises:
instructions that cause the one or more processors to detect, in the fourth area, user deselection of a user group on the list of user groups whose consumption trend is being displayed in the fourth area; and
instructions that cause the one or more processors to remove the consumption trend of the deselected user group from the fourth area.

18. The non-transitory computer-readable storage memory of claim 16, wherein the plurality of instructions further comprises:
instructions that cause the one or more processors to detect, in the fourth area, user selection of a user group on the list of user groups whose consumption trend is not being displayed in the fourth area; and
instructions that cause the one or more processors to display the consumption trend of the selected user group in the fourth area

19. The non-transitory computer-readable storage memory of claim 15, wherein the plurality of instructions further comprises:
instructions that cause the one or more processors to detect user selection of the second area; and
instructions that cause the one or more processors to, in response to detecting the user selection of the second area, display, in a fourth area of the graphical user interface, a plurality of tiles, each tile displaying the coverage information of one of the user groups.

20. The non-transitory computer-readable storage memory of claim 15, wherein the plurality of instructions further comprises:
instructions that cause the one or more processors to detect user selection of the consumption information of a knowledge element in the third area; and
instructions that cause the one or more processors to, in response to detecting the user selection of the object in the third area, display, in a fourth area of the graphical user interface, consumption information of the corresponding knowledge element by each of one or more of the target users.
